(19) United States
(12) Patent Application Publication
(10) Pub. No.: US 2008/0189270 A1
(43) Pub. Date: Aug. 7, 2008

(54) Image retrieval apparatus, image retrieval method, image pickup apparatus, and program

(75) Inventors: Yuuji Takimoto, Tokyo (JP); Katsuhiro Takematsu, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/004,467

(22) Filed: Dec. 20, 2007

(30) Foreign Application Priority Data
Dec. 27, 2006 (JP) P2006-353197

(51) Int. Cl. G06F 7/10; G06F 17/30

(52) U.S. Cl. 707/5; 707/E17.023

(57) ABSTRACT

An image retrieval apparatus retrieving an image may include metadata selecting means for selecting metadata that concerns the image and that belongs to any of a plurality of categories in response to an operation by a user, image retrieving means for retrieving the image on the basis of the metadata selected across the plurality of categories, and display controlling means for controlling display of the retrieved image.

### CROSS-REFERENCE TO RELATED APPLICATIONS

This application claims priority from Japanese Patent Application No. JP 2006-353197 filed in the Japanese Patent Office on Dec. 27, 2006, the entire content of which is incorporated herein by reference.

### BACKGROUND OF THE INVENTION

1. Field of the Invention

The present invention relates to image retrieval apparatuses, image retrieval methods, image pickup apparatuses, and programs. More particularly, the present invention relates to an image retrieval apparatus, an image retrieval method, an image pickup apparatus, and a program that allow users to easily search for desired images.

2. Description of the Related Art

In recent years, digital still cameras are in widespread use. At the same time, the capacities of recording media, such as memory cards, recording images captured by digital still cameras are increasing.

The increase in the capacities of recording media increases the number of images that can be recorded in the recording media. As a result, it is difficult for users to search the recorded images for desired images and to view the desired images.

Hitherto, users have searched for desired image while viewing the dates when images were captured or the images themselves. Accordingly, in order to make it easy to search for images which are frequently viewed, the users create certain folders and record the captured images in the folders to manage the images in units of folders.

Some digital still cameras register keywords (metadata) concerning images of subjects, which have been captured. When users search the captured images for desired images, such digital still cameras retrieve the desired images by using the registered metadata as search conditions to allow the users to easily search for the desired images.

The inventors proposed an information processing apparatus in which the circumstances surrounding users are recognized on the basis of sensing data, which indicates the circumstances surrounding the users, and content files are subjected to weighted retrieval based on the sensing data, the recognized information, and the weights indicating the priority of the recognized information (for example, Japanese Unexamined Patent Application Publication No. 2006-18551).

### SUMMARY OF THE INVENTION

However, there is a problem in that the increase in the number of recorded images makes it difficult for users to search for desired images.

For example, when users want to create folders on the basis of multiple conditions, such as “dog folder” “their own dog folder”, and “dog and cat folder”, in grouping captured images into categories and recording the images in the folders corresponding to the categories, the users need to troublesomely create the folders of the number corresponding to the number of the conditions. In addition, the increase in the number of the folders wastes the spaces of the recording media.

Since images other than the images which users want to view are displayed when the images are managed in units of folders, it is difficult to view only certain images, to display the slideshow of the certain images, and to print the certain images. In addition, when users do not want to show the images before and after desired images to other persons, the users hesitate to make the images themselves open.

Furthermore, when captured images are retrieved on the basis of keywords, it is not possible to retrieve desired images if inappropriate keywords are specified and it is difficult for users to search the recorded images for the desired images.

It may be desirable to retrieve images on the basis of metadata that is selected across multiple categories to allow users to easily search for desired images.

According to an embodiment of the present invention, an image retrieval apparatus retrieving an image may include metadata selecting means for selecting metadata that concerns the image and that belongs to any of a plurality of categories in response to an operation by a user, image retrieving means for retrieving the image on the basis of the metadata selected across the plurality of categories, and display controlling means for controlling display of the retrieved image.

The plurality of categories may include a label that is information concerning a text registered by the user, color information that concerns the proportion of a color in the image, face information that concerns a face displayed in the image, and an attribute of the image. The metadata may belong to any of the label, the color information, the face information, and the attribute.

The attribute may indicate information concerning an apparatus that captures the image, whether the image is protected, whether the image is loaded in another apparatus, whether certain image analysis processing is performed to the image, or whether the original of the image exists.

The image retrieval apparatus may further include label processing means for attaching the label to one or more images in response to an operation by the user.

The label processing means may remove the label attached to one or more images in response to an operation by the user.

The label processing means may create the label in response to an operation by the user.

The image retrieving means may retrieve the image by using logical addition or logical multiplication of the metadata selected across the plurality of categories as a search condition.

According to another embodiment of the present invention, an image retrieval method for an image retrieval apparatus retrieving an image may include selecting metadata that concerns the image and that belongs to any of a plurality of categories in response to an operation by a user, retrieving the image on the basis of the metadata selected across the plurality of categories, and controlling display of the retrieved image.

According to another embodiment of the present invention, a program causing a computer to perform image retrieval processing may include selecting metadata that concerns the image and that belongs to any of a plurality of categories in response to an operation by a user, retrieving the image on the basis of the metadata selected across the plurality of categories, and controlling display of the retrieved image.

In the image retrieval apparatus, the image retrieval method, and the program according to the above embodiments of the present invention, the metadata that concerns the image and that belongs to any of a plurality of categories may be selected in response to an operation by a user, the image may be retrieved on the basis of the metadata selected across the plurality of categories, and display of the retrieved image may be controlled.

According to another embodiment of the present invention, an image pickup apparatus capturing an image may include recording means for recording the captured image, metadata selecting means for selecting metadata that concerns the recorded image and that belongs to any of a plurality of categories in response to an operation by a user, image retrieving means for retrieving the recorded image on the basis of the metadata selected across the plurality of categories, and display controlling means for controlling display of the retrieved image in display means.

In the image pickup apparatus according to the above embodiment of the present invention, the captured image may be recorded, metadata that concerns the recorded image and that belongs to any of a plurality of categories may be selected in response to an operation by a user, the recorded image may be retrieved on the basis of the metadata selected across the plurality of categories, and display of the retrieved image in display means may be controlled.

As described above, according to the present invention, since the image may be retrieved on the basis of the metadata selected across the plurality of categories, it is possible for the user to easily search for a desired image.

According to the present invention, the captured image may be retrieved on the basis of the metadata selected across the plurality of categories, it may be possible for the user to easily search for a desired captured image.

### BRIEF DESCRIPTION OF THE DRAWINGS

FIG. 1 is an external view of a digital still camera according to an embodiment of the present invention;

FIG. 2 is a block diagram showing an example of the internal hardware configuration of the digital still camera in FIG. 1;

FIG. 3 is a block diagram showing an example of the functional configuration of the digital still camera in FIG. 2;

FIG. 4 is a flowchart showing an example of an image retrieval process;

FIG. 5 is a flowchart following the flowchart in FIG. 4, showing an example of the image retrieval process;

FIG. 6 is a schematic view showing an example of an operation window;

FIG. 7 is a schematic view showing an example of a label selection window;

FIG. 8 is a schematic view showing an example of a color information selection window;

FIG. 9 is a schematic view showing an example of a face information selection window;

FIG. 10 is a schematic view showing an example of an attribute selection window;

FIG. 11 is a schematic view showing another example of the label selection window;

FIG. 12 shows an example of a metadata table;

FIG. 13 is a schematic view showing an example of a searching window;

FIG. 14 is a schematic view showing an example of a image retrieval result window;

FIG. 15 is a flowchart showing an example of a label attachment process;

FIG. 16 is a schematic view showing an example of an image list window;

FIG. 17 is a schematic view showing another example of the image list window;

FIG. 18 is a schematic view showing another example of the image list window;

FIG. 19 is a schematic view showing an example of an image window;

FIG. 20 is a schematic view showing another example of the image list window;

FIG. 21 is a schematic view showing another example of the image list window;

FIG. 22 is a schematic view showing another example of the image list window;

FIG. 23 is a schematic view showing an example of an image window;

FIG. 24 is a flowchart showing an example of a label removal process;

FIG. 25 is a schematic view showing another example of the image list window;

FIG. 26 is a schematic view showing another example of the image list window;

FIG. 27 is a schematic view showing another example of the image window in FIG. 19;

FIG. 28 is a schematic view showing another example of the image list window;

FIG. 29 is a schematic view showing an example of a removal image list window;

FIG. 30 is a schematic view showing another example of the removal image list window;

FIG. 31 is a schematic view showing another example of the image window in FIG. 23;

FIG. 32 is a flowchart showing an example of a label creation process;

FIG. 33 is a schematic view showing another example of the image list window;

FIG. 34 is a schematic view showing an example of a label list window;

FIG. 35 is a schematic view showing an example of an input window; and

FIG. 36 is a schematic view showing an example of an image window.

### DETAILED DESCRIPTION

Before describing embodiments of the present invention, the correspondence between the features of the claims and the specific elements disclosed in embodiments of the present invention is discussed below. This description is intended to assure that embodiments supporting the claimed invention are described in this specification. Thus, even if an element in the following embodiments is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

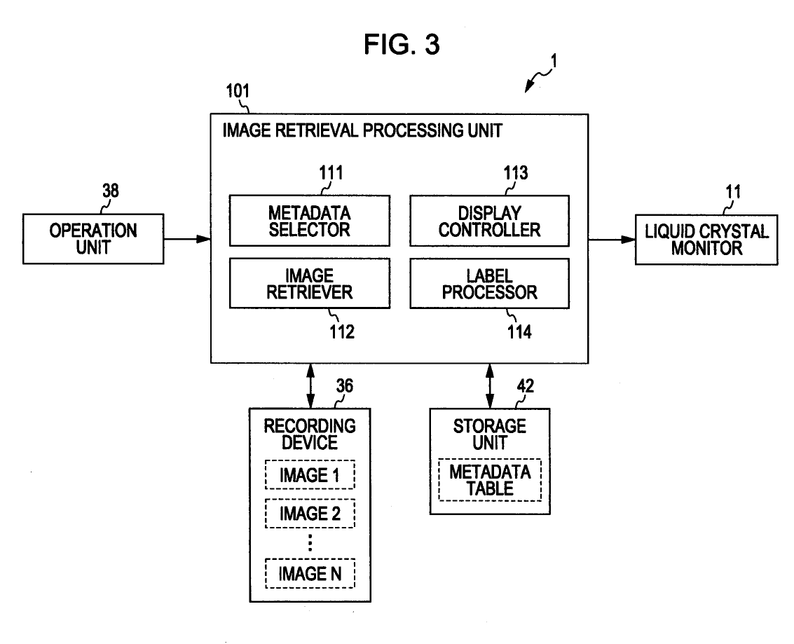

According to an embodiment of the present invention, an image retrieval apparatus (for example, a digital still camera 1 in FIG. 3) retrieving an image includes metadata selecting means (for example, a metadata selector 111 in FIG. 3) for selecting metadata that concerns the image and that belongs to any of a plurality of categories in response to an operation by a user, image retrieving means (for example, a image retriever 112 in FIG. 3) for retrieving the image on the basis of the metadata selected across the plurality of categories, and display controlling means (for example, a display controller 113 in FIG. 3) for controlling display of the retrieved image.

The plurality of categories may include a label that is information concerning a text registered by the user, color information that concerns the proportion of a color in the image, face information that concerns a face displayed in the image, and an attribute of the image. The metadata may belong to any of the label, the color information, the face information, and the attribute.

The attribute may indicate information concerning an apparatus that captures the image, whether the image is protected, whether the image is loaded in another apparatus, whether certain image analysis processing is performed to the image, or whether the original of the image exists.

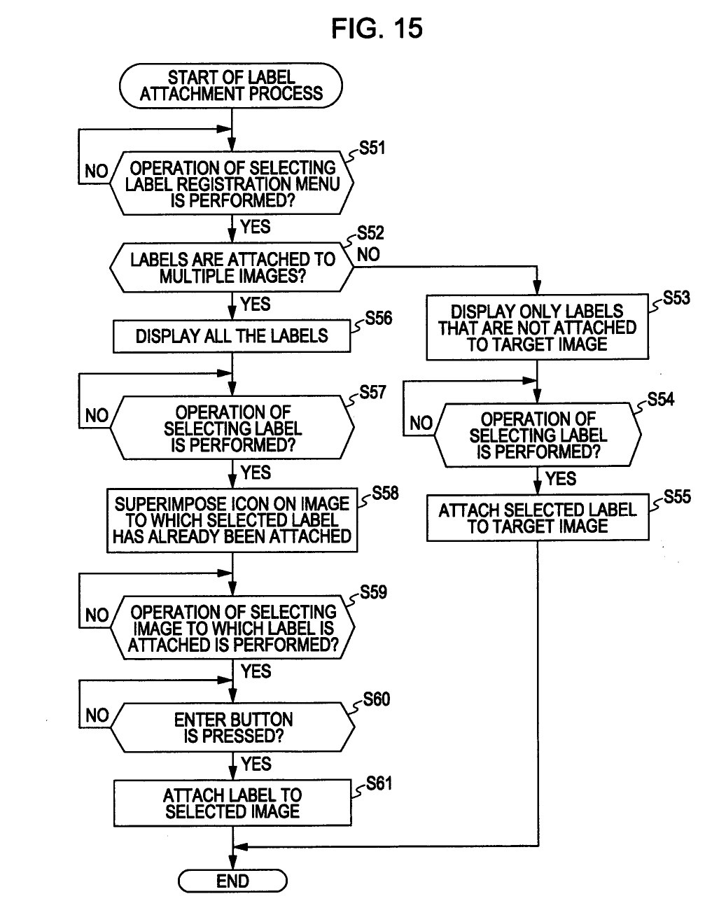

The image retrieval apparatus may further include label processing means (for example, a label processor 114 in FIG. 3) for attaching the label to one or more images in response to an operation by the user (for example, Step S55 or S61 in FIG. 15).

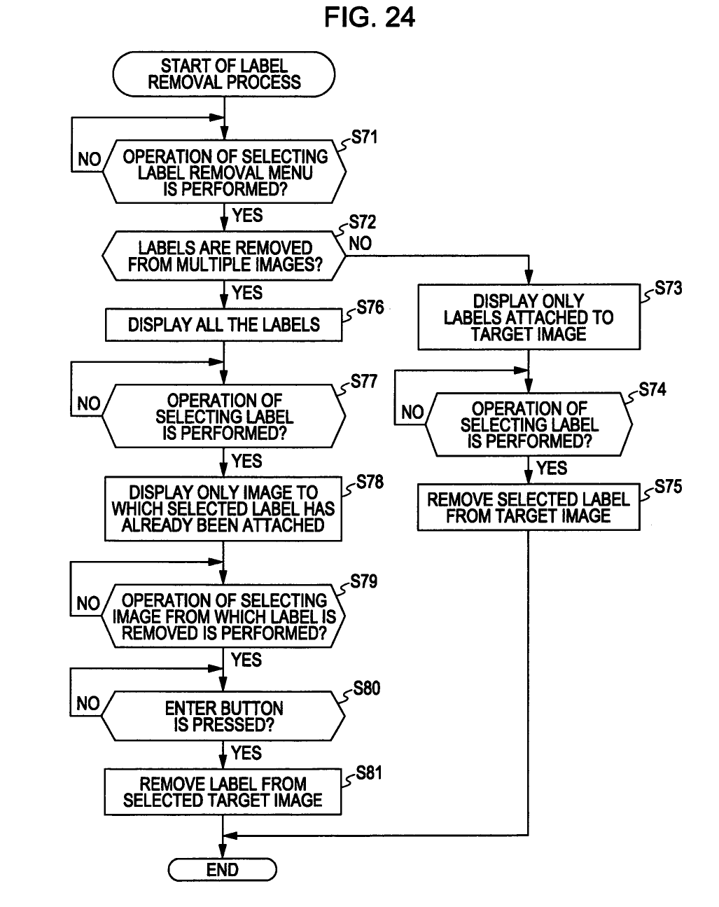

The label processing means may remove the label attached to one or more images in response to an operation by the user (for example, Step S75 or S81 in FIG. 24).

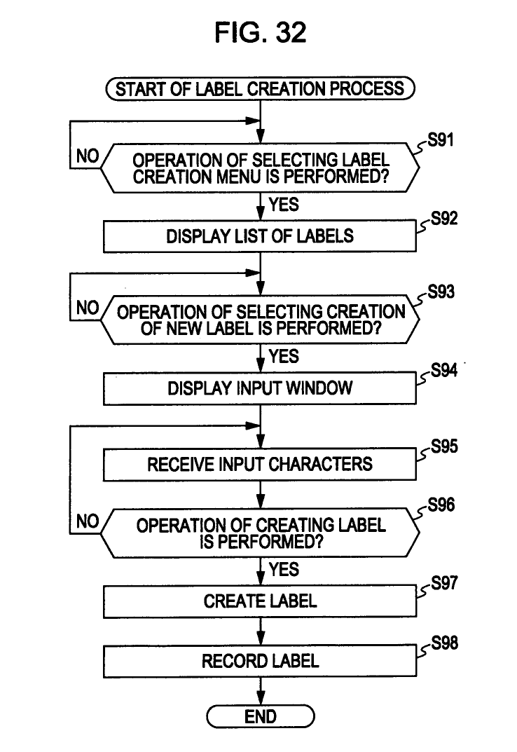

The label processing means may create the label in response to an operation by the user (for example, Step S97 in FIG. 32).

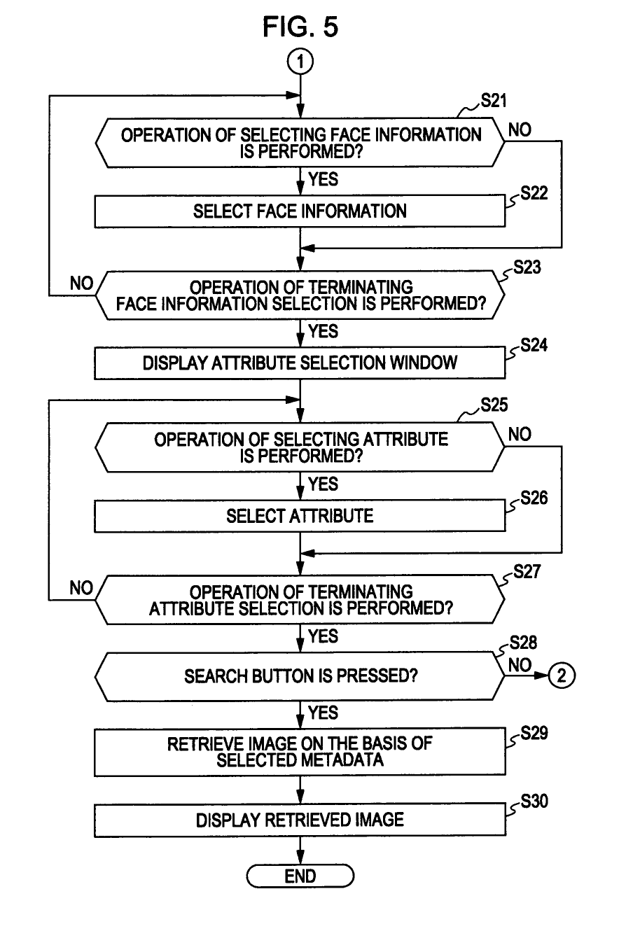

The image retrieving means may retrieve the image by using logical addition or logical multiplication of the metadata selected across the plurality of categories as a search condition (for example, Step S29 in FIG. 5).

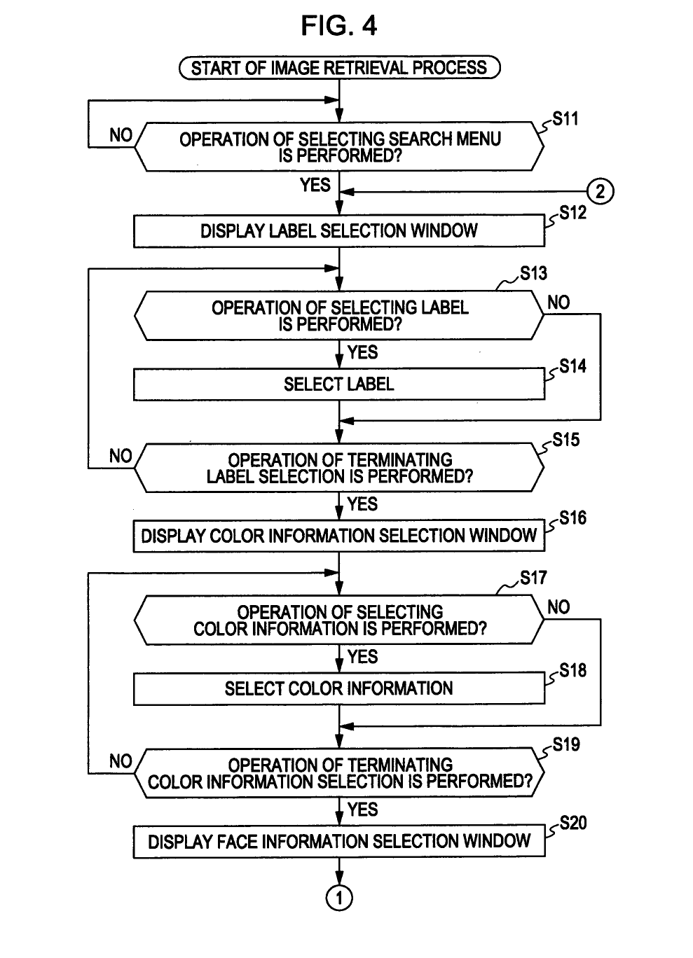

According to other embodiments of the present invention, an image retrieval method for an image retrieval apparatus retrieving an image and a program causing a computer to perform certain image retrieval processing include the steps of selecting metadata that concerns the image and that belongs to any of a plurality of categories in response to an operation by a user (for example, Step S14 or S18 in FIG. 4 or S22 or S26 in FIG. 5), retrieving the image on the basis of the metadata selected across the plurality of categories (for example, Step S29 in FIG. 5), and controlling display of the retrieved image (for example, Step S30 in FIG. 5).

According to another embodiment of the present invention, an image pickup apparatus (for example, the digital still camera 1 in FIG. 3) capturing an image includes recording means (for example, a recording device 36 in FIG. 3) for recording the captured image, metadata selecting means (for example, the metadata selector 111 in FIG. 3) for selecting metadata that concerns the recorded image and that belongs to any of a plurality of categories in response to an operation by a user, image retrieving means (for example, the image retriever 112 in FIG. 3) for retrieving the recorded image on the basis of the metadata selected across the plurality of categories, and display controlling means (for example, the display controller 113 in FIG. 3) for controlling display of the retrieved image in display means (for example, a liquid crystal monitor 11 in FIG. 3).

Exemplary embodiments of the present invention will herein be described with reference to the attached drawings.

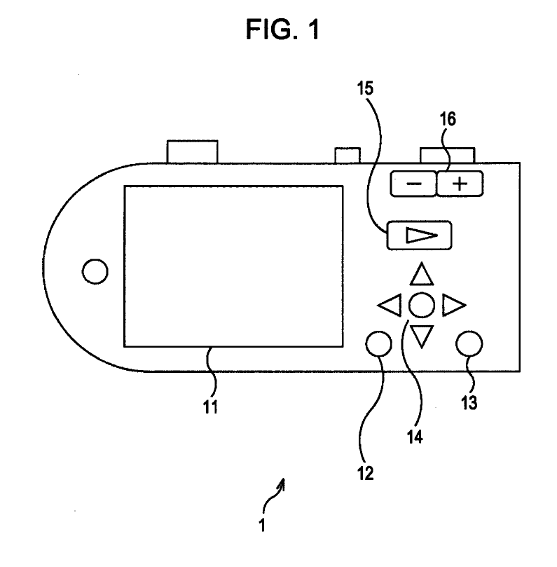

FIG. 1 is an external view of a digital still camera 1 according to an embodiment of the present invention.

Referring to FIG. 1, a liquid crystal monitor 11 on which various images are displayed is provided on the left side on the rear side of the digital still camera 1. A menu button 12, a search button 13, and operation buttons 14 are provided on the right side thereon. A playback button 15 is provided at the upper side of the operation buttons 14. Zoom buttons 16 are provided at the upper side of the playback button 15.

A user operates the menu button 12 to display a menu window on the liquid crystal monitor 11, and operates the search button 13 to search for a captured image. The user operates the corresponding operation button 14, for example, to move a cursor used for selecting an item in the menu window displayed on the liquid crystal monitor 11 or to determine the selection of the item.

The user operates the playback button 15, for example, to play back a captured image and operates either of the zoom buttons 16 to adjust the zoom ratio.

Although only the rear side of the digital still camera 1 is shown in FIG. 1 for simplicity, for example, a lens unit used for gathering light from a subject and adjusting the focus is provided on the front side of the digital still camera 1. The digital still camera 1 uses the lens unit and others to capture an image of the subject.

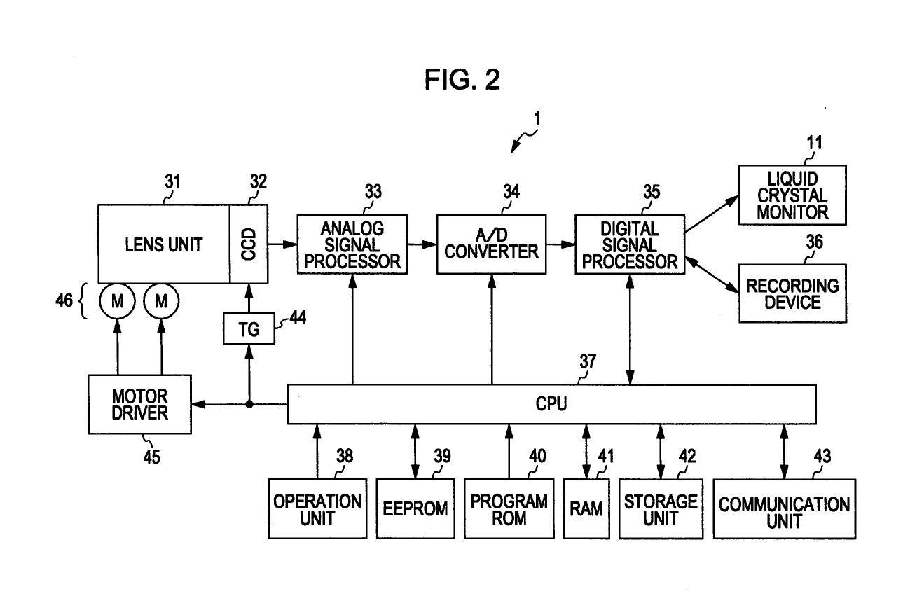

FIG. 2 is a block diagram showing an example of the internal hardware configuration of the digital still camera 1 shown in FIG. 1. The digital still camera 1 includes the lens unit 31, a charge coupled device (CCD) 32, an analog signal processor 33, an analog-to-digital (A/D) converter 34, a digital signal processor 35, the liquid crystal monitor 11, a recording device 36, a central processing unit (CPU) 37, an operation unit 38, an electronically erasable and programmable read only memory (EEPROM) 39, a program read only memory (ROM) 40, a random access memory (RAM) 41, a storage unit 42, a communication unit 43, a timing generator (TG) 44, a motor driver 45, and an actuator 46.

The same reference numerals are used in FIG. 2 to identify the same components shown in FIG. 1. A description of such components is omitted herein.

The CCD 32 is composed of a CCD sensor. The CCD 32 operates in accordance with a timing signal supplied from the timing generator 44 to receive light from the subject through the lens unit 31 and to perform photoelectric conversion and supplies an analog image signal, which is an electrical signal corresponding to the amount of the received light, to the analog signal processor 33. The CCD 32 is not limited to the CCD sensor and may be any image pickup device, such as a complementary metal oxide semiconductor (CMOS) sensor, as long as the image pickup device generates image signals in units of pixels.

The analog signal processor 33 performs analog signal processing, such as amplification, to the analog image signal supplied from the CCD 32 under the control of the CPU 37 and supplies the image signal resulting from the analog signal processing to the A/D converter 34.

The A/D converter 34 performs A/D conversion to the analog image signal supplied from the analog signal processor 33 under the control of the CPU 37 and supplies the image data, which is a digital signal, resulting from the A/D conversion to the digital signal processor 35.

The digital signal processor 35 performs digital signal processing, such as noise reduction, to the image data supplied from the A/D converter 34 under the control of the CPU 37 and supplies the image data to the liquid crystal monitor 11 where the image data is displayed. In addition, the digital signal processor 35 compresses the image data supplied from the A/D converter 34 in, for example, Joint Photographic Experts Group (JPEG) format and supplies the compressed image data to the recording device 36 where the image data is recorded. Furthermore, the digital signal processor 35 decompresses the compressed image data recorded in the recording device 36 and supplies the image data resulting from the decompression to the liquid crystal monitor 11 where the image data is displayed.

The recording device 36 is, for example, a semiconductor memory, such as a memory card, or another removable recording medium, such as a digital versatile disk (DVD). The recording device 36 is easily detachable from the digital still camera 1.

The CPU 37 executes programs recorded in the program ROM 40 to control the components in the digital still camera 1 and performs a variety of processing in response to signals from the operation unit 38.

The operation unit 38 includes, for example, the menu button 12, the search button 13, the operation buttons 14, the playback button 15, and the zoom buttons 16 shown in FIG. 1. The operation unit 38 is operated by the user and supplies an operation signal corresponding to the user's operation to the CPU 37.

The EEPROM 39 stores data that is required to be held even when the digital still camera 1 is turned off under the control of the CPU 37. The data includes a variety of information set in the digital still camera 1.

The program ROM 40 stores the programs executed by the CPU 37 and data necessary for the CPU 37 to execute the programs. The RAM 41 temporarily stores programs and data necessary for the CPU 37 to perform the variety of processing.

The storage unit 42 and the communication unit 43 are also connected to the CPU 37. The storage unit 42 is a recording medium, such as a flash memory or a hard disk. The communication unit 43 controls, for example, wireless communication with another apparatus.

The storage unit 42 stores, for example, metadata concerning captured images under the control of the CPU 37. The digital still camera 1 may not include the storage unit 42 and the variety of data stored in the storage unit 42 may be stored in the EEPROM 39.

The timing generator 44 supplies the timing signal to the CCD 32 under the control of the CPU 37. The timing signal supplied from the timing generator 44 to the CCD 32 is used to control the exposure time or the shutter speed in the CCD 32.

The motor driver 45 drives the actuator (motor) 46 under the control of the CPU 37. The driving of the actuator 46 causes the lens unit 31 to protrude from the case of the digital still camera 1 or to be housed in the case of the digital still camera 1. The driving of the actuator 46 also adjusts the aperture in the lens unit 31 and moves the focusing lens in the lens unit 31.

In the digital still camera 1 having the above configuration, the CCD 32 receives light from the subject through the lens unit 31 to perform the photoelectric conversion and outputs the analog image signal resulting from the photoelectric conversion. The analog image signal output from the CCD 32 passes through the analog signal processor 33 and the A/D converter 34 to be converted into digital image data that is supplied to the digital signal processor 35.

The digital signal processor 35 supplies the image data supplied from the A/D converter 34 to the liquid crystal monitor 11 where the so-called through image is displayed.

When the user presses a shutter button, which is used for recording a captured image, in the operation unit 38, a signal corresponding to the user's operation is supplied from the operation unit 38 to the CPU 37. The CPU 37 controls the digital signal processor 35 in response to the signal that corresponds to the operation of the shutter button and that is supplied from the operation unit 38 so as to compress the image data supplied from the A/D converter 34 to the digital signal processor 35, and records the compressed image data in the recording device 36.

Photography is performed in the above manner.

The programs executed by the CPU 37 may be recorded in the recording device 36 and may be provided to the user as a package medium, instead of being installed or stored in advance in the program ROM 40. In this case, the programs are supplied from the recording device 36 to the EEPROM 39 through the digital signal processor 35 and the CPU 37 and are stored in the EEPROM 39 to be installed in the digital still camera 1. The programs executed by the CPU 37 may be directly downloaded from a download site to the digital still camera 1 in FIG. 2 or may be downloaded by a computer (not shown) to be supplied to the digital still camera 1. The programs are stored in the EEPROM 39 to be installed in the digital still camera 1.

The hardware configuration of the digital still camera 1 is not limited to the one shown in FIG. 2. The digital still camera 1 may have another configuration at least having a functional configuration shown in FIG. 3.

FIG. 3 is a block diagram showing an example of the functional configuration of the digital still camera 1 shown in FIG. 2.

The same reference numerals are used in FIG. 3 to identify the same components shown in FIG. 2. A description of such components is omitted herein. Referring to FIG. 3, rectangular areas surrounded by solid lines represent blocks serving as the components of the digital still camera 1 and rectangular areas surrounded by broken lines represent certain information.

An image retrieval processing unit 101 performs certain processing relating to image retrieval on the basis of an operation signal supplied from the operation unit 38.

The image retrieval processing unit 101 includes a metadata selector 111, an image retriever 112, a display controller 113, and a label processor 114.

The metadata selector 111 selects metadata in response to a user's operation and supplies the selected metadata to the image retriever 112.

The metadata is information concerning an image and belongs to any of multiple categories. The multiple categories include, for example, a label, color information, face information, and an attribute of an image. The label is information concerning a text registered by the user. The color information concerns the proportion of a color in the image. The face information concerns a person (face) displayed in the image. In other words, the metadata belongs to any of the categories including the label, the color information, the face information, and the attribute.

The metadata belonging to each category, that is, the label, the color information, the face information, or the attribute, is also hereinafter referred to as the label, the color information, the face information, or the attribute, like each category, for simplicity.

The attribute of an image indicates, for example, whether the image is protected, information concerning an apparatus by which the image is captured, whether the image is loaded in another apparatus, such as a personal computer (PC), whether certain image analysis processing is performed to the image, or whether the original of the image exists.

Specifically, the metadata selector 111 selects metadata belonging to a category, such as the label, the color information, the face information, or the attribute, in response to a user's operation.

The categories may include a comment on the image and the date when the image is captured, in addition to the label, the color information, the face information, and the attribute described above. Categories can be arbitrarily set as long as the categories are used to classify the metadata concerning the image.

The image retriever 112 retrieves images 1 to N (N is a natural number) recorded in the recording device 36 on the basis of the metadata (retrieval conditions) supplied from the metadata selector 111 and a metadata table stored in the storage unit 42. The image retriever 112 supplies the result of the image retrieval to the display controller 113.

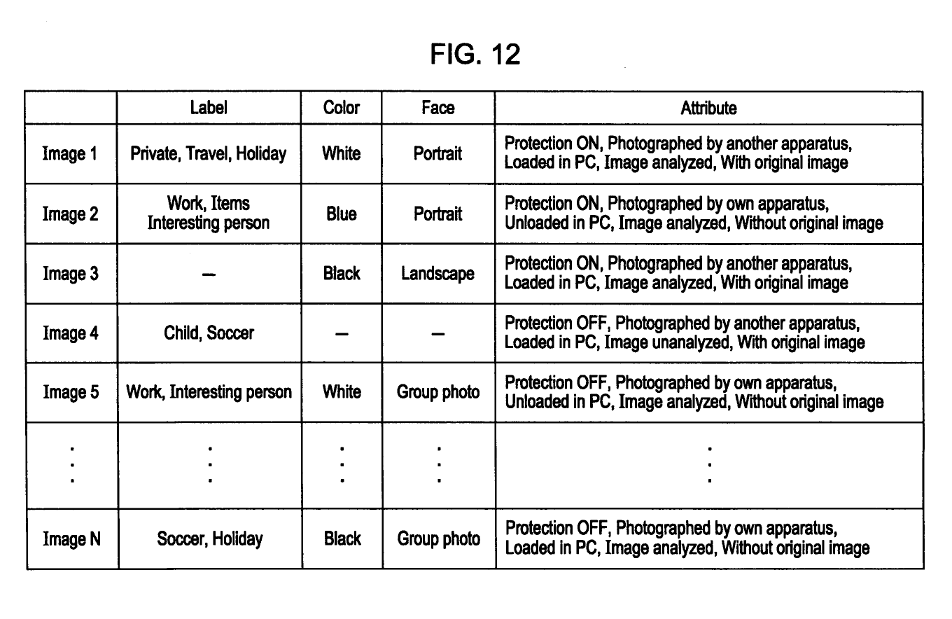

The metadata table includes the images 1 to N recorded in the recording device 36 in association with the metadata concerning the images 1 to N. The metadata table will be described in detail below with reference to FIG. 12.

The display controller 113 controls display of various windows on the liquid crystal monitor 11. For example, the display controller 113 displays a window corresponding to the result of the image retrieval supplied from the image retriever 112 on the liquid crystal monitor 11.

The label processor 114 performs a variety processing relating the label.

For example, the label processor 114 attaches a label to an image or removes a label attached to an image in response to a user's operation. In addition, the label processor 114 creates a new label and records the created new label along with the other labels in response to a user's operation.

FIGS. 4 and 5 are flowcharts showing an example of an image retrieval process by the image retrieval processing unit 101.

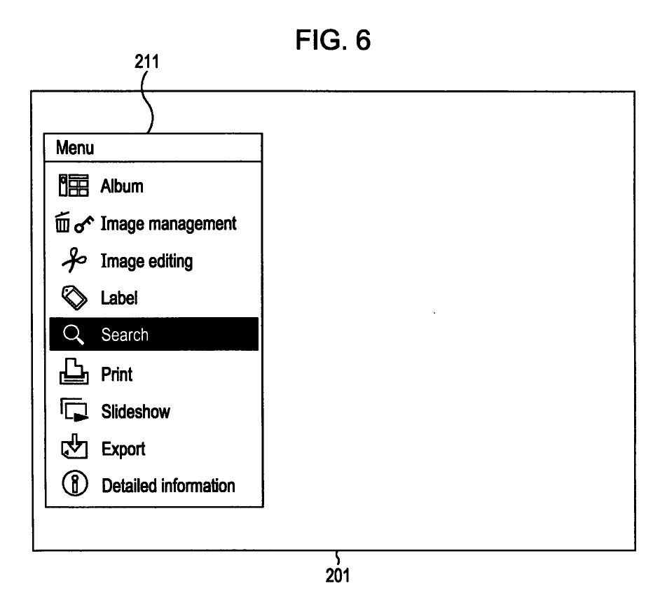

Referring to FIG. 4, in Step S11, the image retrieval processing unit 101 determines whether the user selects any search menu from, for example, a menu 211 on an operation window 201 shown in FIG. 6 on the basis of an operation signal supplied from the operation unit 38.

Referring to FIG. 6, the menu 211 is displayed in the operation window 201 displayed on the liquid crystal monitor 11. The menu 211 is used to select a menu from various menus including “Album”, “Image management”, “Image editing”, “Label”, “Search”, “Print”, “Slideshow”, “Export”, and “Detailed information”.

Referring back to the flowchart in FIG. 4, if the image retrieval processing unit 101 determines in Step S11 that the user does not select any search menu, the process goes back to Step S11 to repeat the determination until the user selects any search menu.

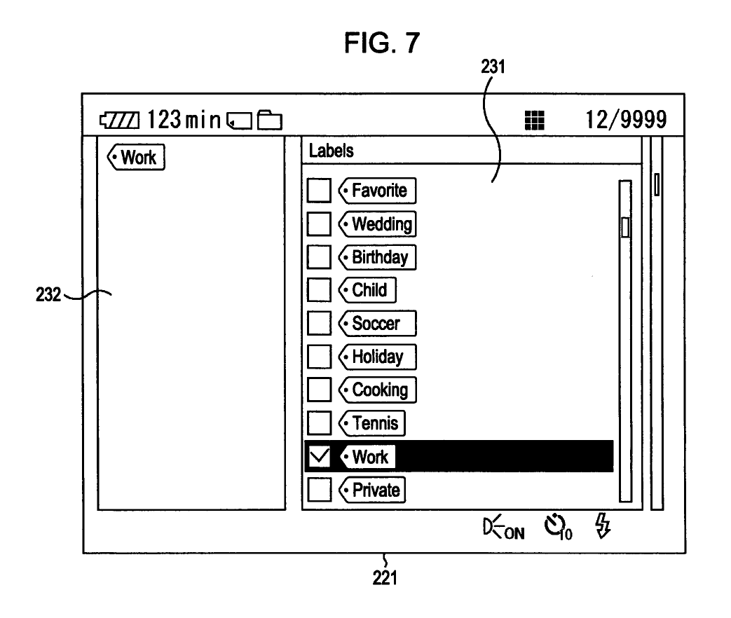

If the image retrieval processing unit 101 determines in Step S11 that the user selects any search menu, then in Step S12, the display controller 113 displays, for example, a label selection window 221 shown in FIG. 7 on the liquid crystal monitor 11.

Referring to FIG. 7, a label list 231, which a list of labels registered by the user, is displayed on the right side of the label selection window 221. A search condition list 232, which is a list of search conditions including the label selected from the label list 231 on the right side, is displayed on the left side of the label selection window 221.

Specifically, for example, “Favorite”, “Wedding”, “Birthday”, “Child”, “Soccer”, “Holiday”, “Cooking”, “Tennis”, “Work”, and “Private” labels are displayed in the label list 231 as the labels registered by the user.

Referring back to the flowchart in FIG. 4, in Step S13, the image retrieval processing unit 101 determines whether the user checks any check box at the left side of the labels displayed in the label list 231 in the label selection window 221 in FIG. 7 on the basis of an operation signal supplied from the operation unit 38 to determine whether the user selects any label.

If the image retrieval processing unit 101 determines in Step S13 that the user selects any label, then in Step S14, the metadata selector 111 selects the label selected by the user as the search condition.

For example, if the user selects the “Work” label from the labels displayed in the label list 231 in the label selection window 221 in FIG. 7, the check box at the left side of the “Work” label is checked and the “Work” is displayed in the search condition list 232 as the selected label. The metadata selector 111 selects the “Work” label selected by the user as the search condition.

If the image retrieval processing unit 101 determines in Step S13 that the user does not select any label, the process skips Step S14 and goes to Step S15.

In Step S15, the image retrieval processing unit 101 determines whether the user terminates the label selection on the basis of an operation signal supplied from the operation unit 38.

If the image retrieval processing unit 101 determines in Step S15 that the user does not terminate the label selection, the process goes back to Step S13 to repeat the Steps S13 to S15 until the user terminates the label selection.

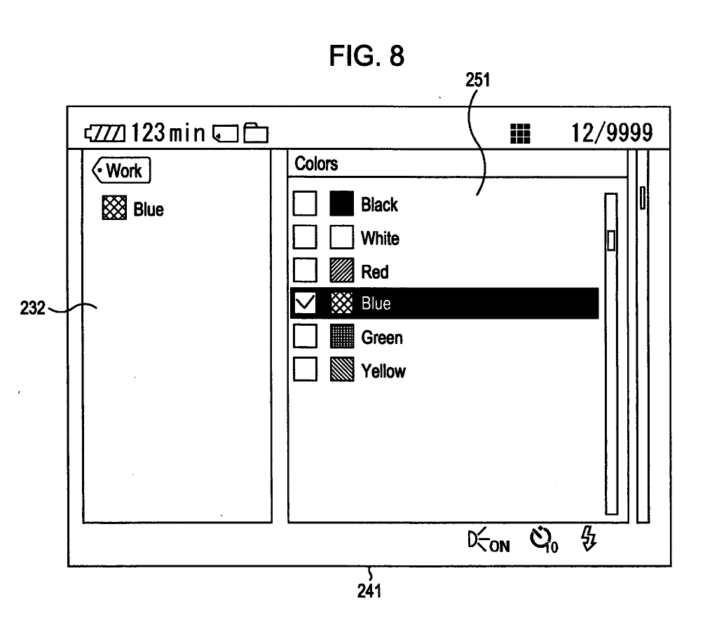

If the mage retrieval processing unit 101 determines in Step S15 that the user terminates the label selection, then in Step S16, the display controller 113 displays, for example, a color information selection window 241 shown in FIG. 8 on the liquid crystal monitor 11.

Referring to FIG. 8, a color list 251, which is a list of colors included in the image, is displayed on the right side of the color information selection window 241. The search condition list 232, resulting from addition of color information selected from the color list 251 on the right side to the list of the selected label, is displayed on the left side of the color information selection window 241.

Specifically, a list of colors, such as “Black”, “White”, “Red”, “Blue”, “Green”, and “Yellow”, included in the image is displayed in the color list 251. For example, when the user wants to search for an image largely occupied by “Black”, the user selects the “Black” from the color list 251. The same applies to the other colors.

Referring back to the flowchart in FIG. 4, in Step S17, the image retrieval processing unit 101 determines whether the user checks any check box at the left side of the colors displayed in the color list 251 in the color information selection window 241 in FIG. 8 on the basis of an operation signal supplied from the operation unit 38 to determine whether the user selects any color information.

If the image retrieval processing unit 101 determines in Step S17 that the user selects any color information, then in Step S18, the metadata selector 111 selects the color information selected by the user as the search condition.

For example, if the user selects the “Blue” from the colors displayed in the color list 251 in the color information selection window 241 in FIG. 8, the check box at the left side of the “Blue” color information is checked and the “Blue” is displayed in the search condition list 232 as the selected color information along with the “Work” label selected in the label selection window 221 in FIG. 7. The metadata selector 111 selects the “Blue” color information selected by the user as the search condition.

If the image retrieval processing unit 101 determines in Step S17 that the user does not select any color information, the process skips Step S18 and goes to Step S19.

In Step S19, the image retrieval processing unit 101 determines whether the user terminates the color information selection on the basis of an operation signal supplied from the operation unit 38.

If the image retrieval processing unit 101 determines in Step S19 that the user does not terminate the color information selection, the process goes back to Step S17 to repeat the Steps S17 to S19 until the user terminates the color information selection.

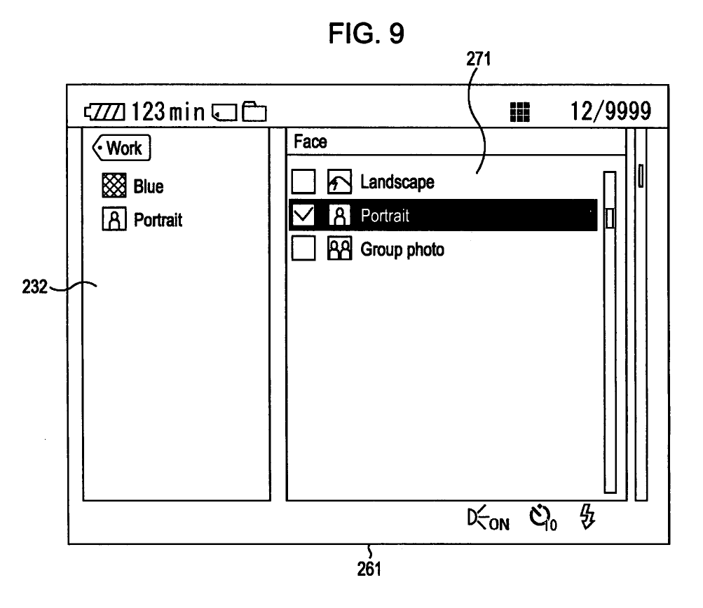

If the mage retrieval processing unit 101 determines in Step S19 that the user terminates the color information selection, then in Step S20, the display controller 113 displays, for example, a face information selection window 261 shown in FIG. 9 on the liquid crystal monitor 11.

Referring to FIG. 9, a face list 271, which is a list of search conditions based of faces (persons) included in the image, is displayed on the right side of the face information selection window 261. The search condition list 232, resulting from addition of face information selected from the face list 271 on the right side to the list of the selected label and color information, is displayed on the left side of the face information selection window 261.

Specifically, a list of search conditions, such as “Landscape”, “Portrait”, and “Group photo”, based on faces (persons) included in the image is displayed in the face list 271. For example, when the user wants to search for “an image including no person”, the user selects the “Landscape” from the face list 271. When the user wants to search for “an image including one or two persons”, the user selects the “Portrait”. When the user wants to search for “an image including many persons”, the user selects the “Group photo”.

Referring back to the flowchart in FIG. 5, in Step S21, the image retrieval processing unit 101 determines whether the user checks any check box at the left side of the search conditions displayed in the face list 271 in the face information selection window 261 in FIG. 9 on the basis of an operation signal supplied from the operation unit 38 to determine whether the user selects any face information.

If the image retrieval processing unit 101 determines in Step S21 that the user selects any face information, then in Step S22, the metadata selector 111 selects the face information selected by the user as the search condition.

For example, if the user selects the “Portrait” from the search conditions displayed in the face list 271 in the face information selection window 261 in FIG. 9, the check box at the left side of the search condition based on the “Portrait” face information is checked. The “Portrait” is displayed in the search condition list 232 as the selected face information along with the “Work” label selected in the label selection window 221 in FIG. 7 and the “Blue” color information selected in the color information selection window 241 in FIG. 8. The metadata selector 111 selects the “Portrait” face information selected by the user as the search condition.

If the image retrieval processing unit 101 determines in Step S21 that the user does not select any face information, the process skips Step S22 and goes to Step S23.

In Step S23, the image retrieval processing unit 101 determines whether the user terminates the face information selection on the basis of an operation signal supplied from the operation unit 38.

If the image retrieval processing unit 101 determines in Step S23 that the user does not terminate the face information selection, the process goes back to Step S21 to repeat the Steps S21 to S23 until the user terminates the face information selection.

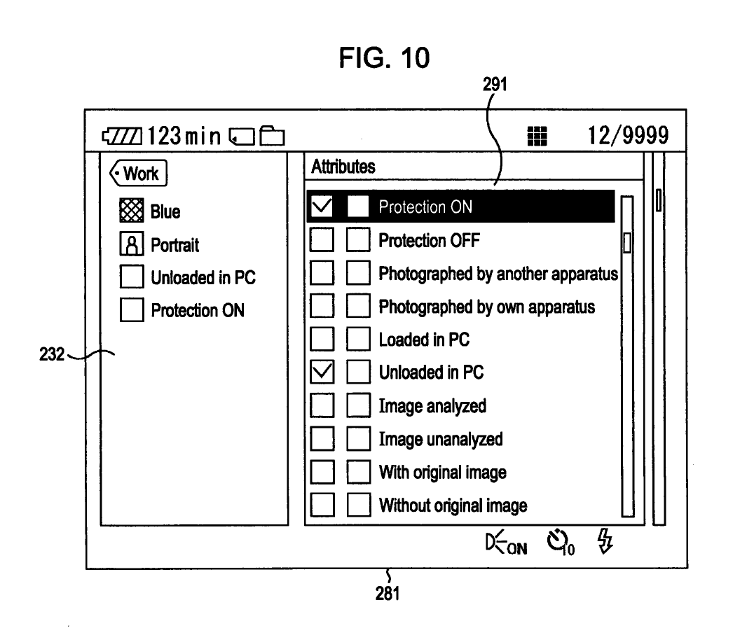

If the mage retrieval processing unit 101 determines in Step S23 that the user terminates the face information selection, then in Step S24, the display controller 113 displays, for example, an attribute selection window 281 shown in FIG. 10 on the liquid crystal monitor 11.

Referring to FIG. 10, an attribute list 291, which is a list of attributes, is displayed on the right side of the attribute selection window 281. The search condition list 232, resulting from addition of an attribute selected from the attribute list 291 on the right side to the list of the selected label, color information, and face information, is displayed on the left side of the attribute selection window 281.

Specifically, a list of attributes, such as “Protection ON”, “Protection OFF”, “Photographed by another apparatus”, “Photographed by own apparatus”, “Loaded in PC”, “Unloaded in PC”, “Image analyzed”, “Image unanalyzed”, “With original image”, and “Without original image”, is displayed in the attribute list 291.

The “Protection ON” indicates that the target image is protected from being deleted, and the “Protection OFF” indicates that the target image is not protected from being deleted. The “Photographed by another apparatus” indicates that the target image is photographed by another apparatus, for example, the target image is received or imported from another digital still camera. The “Photographed by own apparatus” indicates that the target image is photographed by the digital still camera 1.

The “Loaded in PC” indicates that the captured image is loaded in another apparatus, such as a PC. The “Unloaded in PC” indicates that the captured image is not loaded in another apparatus, such as a PC. The “With original image” indicates that the original of the captured image exists, and the “Without original image” indicates that the original of the captured image does not exist.

The “Image analyzed” indicates that the target image is subjected to certain image analysis processing, and the “Image unanalyzed” indicates that the target image is not subjected to certain image analysis processing. The color information or face information included in the image is analyzed in the image analysis processing. The color or face information concerning each image is acquired by the image analysis processing.

Referring back to the flowchart in FIG. 5, in Step S25, the image retrieval processing unit 101 determines whether the user checks any check box at the left side of the attributes displayed in the attribute list 291 in the attribute selection window 281 in FIG. 10 on the basis of an operation signal supplied from the operation unit 38 to determine whether the user selects any attribute.

If the image retrieval processing unit 101 determines in Step S25 that the user selects any attribute, then in Step S26, the metadata selector 111 selects the attribute selected by the user as the search condition.

For example, if the user selects the two attributes, the “Unloaded in PC” and the “Protection ON”, from the attributes displayed in the attribute list 291 in the attribute selection window 281 in FIG. 10, the check boxes at the left side of the “Unloaded in PC” and the “Protection ON” are checked. The “Unloaded in PC” and the “Protection ON” are displayed in the search condition list 232 as the selected attributes along with the “Work” label selected in the label selection window 221 in FIG. 7, the “Blue” color information selected in the color information selection window 241 in FIG. 8, and the “Portrait” face information selected in the face information selection window 261 in FIG. 9. The metadata selector 111 selects the “Unloaded in PC” and the “Protection ON” attributes selected by the user as the search conditions.

If the image retrieval processing unit 101 determines in Step S25 that the user does not select any attribute, the process skips Step S26 and goes to Step S27.

In Step S27, the image retrieval processing unit 101 determines whether the user terminates the attribute selection on the basis of an operation signal supplied from the operation unit 38.

If the image retrieval processing unit 101 determines in Step S27 that the user does not terminate the attribute selection, the process goes back to Step S25 to repeat the Steps S25 to S27 until the user terminates the attribute selection.

If the image retrieval processing unit 101 determines in Step S27 that the user terminates the attribute selection, then in Step S28, the image retrieval processing unit 101 determines whether the user presses the search button used for instructing execution of the image retrieval on the basis of an operation signal supplied from the operation unit 38.

If the image retrieval processing unit 101 determines in Step S28 that the user does not press the search button, the process goes back to Step S12 to repeat Steps S12 to S28 until the user presses the search button.

The repetition of Steps S12 to S28 allows the user to repeatedly select the search conditions including the label, the color information, the face information, and the attribute. For example, the display controller 113 displays the label selection window 221 in FIG. 7 on the liquid crystal monitor 11 again. Then, if the user selects “Items” and “Interesting person” from the labels displayed in the label list 231 in the label selection window 221 in FIG. 7, the metadata selector 111 further selects the labels selected by the user as the search conditions.

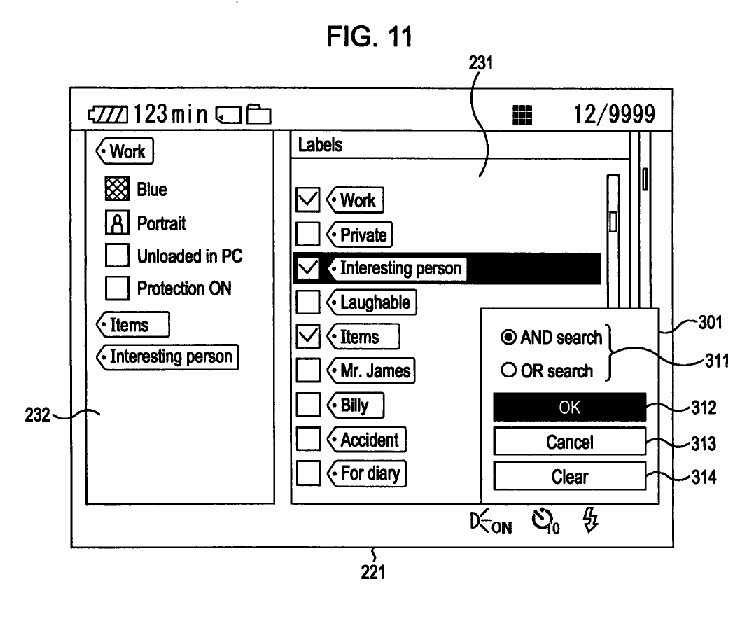

After Steps S12 to S27 are repeated, then in Step S28, the image retrieval processing unit 101 determines whether the user presses a “OK” button 312 used for instructing the execution of the image retrieval in a retrieval execution window 301 superimposed on the label selection window 221 in FIG. 11 to determine whether the search button is pressed.

The retrieval execution window 301 in FIG. 11 is superimposed on the search condition selection window if the user operates the operation unit 38 including the search button 13 in FIG. 1 when the search condition selection window, the label selection window 221 in FIG. 7 or the label selection window 221 in FIG. 11, is displayed on the liquid crystal monitor 11.

A radio button 311 with which “AND search” or “OR search” is selected, the “OK” button 312, a “Cancel” button 313, and a “Clear” button 314 are displayed in the retrieval execution window 301. The “Cancel” button 313 is used for instructing the image retrieval processing unit 101 to cancel the image retrieval. The “Clear” button 314 is used for instructing the image retrieval processing unit 101 to clear the search conditions already selected, such as the “Work”, “Blue”, “Portrait”, “Unloaded in PC”, “Protection ON”, “Items”, and “Interesting person”.

According to the embodiment of the present invention, the “AND” in the “AND search” has the same meaning as that of logical multiplication, which is a logical function. For example, if “A” and “B” are selected as the search conditions in the “AND search”, an image satisfying both the conditions “A” and “B” is retrieved. The “OR” in the “OR search” has the same meaning as that of logical addition, which is a logical function. For example, if “A” and “B” are selected as the search conditions in the “OR search”, an image satisfying at least one of the “A” and “B” conditions is retrieved.

According to the embodiment of the present invention, “NOT search” (not shown) allowing the search by logical inversion may be selected with the radio button 311, in addition to the “AND search” and the “OR search”. With “NOT search”, for example, it is possible to retrieve an image that includes a “dog” image but does not include an “own dog” image.

The “AND search”, the “OR search”, or the “NOT search” may be set for every category, that is, for each of the label, the color information, the face information, and the attribute, to perform the retrieval.

Referring back to FIG. 5, if the image retrieval processing unit 101 determines in Step S28 that the user presses the search button, then in Step S29, the image retriever 112 retrieves one or more images on the basis of the metadata selected by the metadata selector 111.

As described above, for example, a metadata table shown in FIG. 12 is stored in the storage unit 42. The metadata table includes metadata concerning images recorded in the recording device 36.

FIG. 12 shows an example of the metadata table.

In the example of the metadata table in FIG. 12, the first line shows items for each piece of metadata and the second and subsequent lines show data concerning the images 1 to N (N is a natural number) recorded in the recording device 36. The first column shows the image name, the second column shows the “Label”, the third column shows the “color (color information)”, the fourth column shows the “face (face information)”, and the fifth column shows the “attribute”.

In the metadata table shown in FIG. 12, “Private”, “Travel”, and “Holiday” labels, “White” color information, “Portrait” face information, and “Protection ON”, “Photographed by another apparatus”, “Loaded in PC”, “Image analyzed”, and “With original image” attributes are stored for the image 1.

“Work”, “Items”, and “Interesting person” labels, “Blue” color information, “Portrait” face information, and “Protection ON”, “Photographed by own apparatus”, “Unloaded in PC”, “Image analyzed”, “Without original image” attributes are stored for the image 2. “Black” color information, “Landscape” face information, and “Protection ON”, “Photographed by another apparatus”, “Loaded in PC”, “Image analyzed”, “With original image” attributes are stored for the image 3.

“Child” and “Soccer” labels and “Protection OFF”, “Photographed by another apparatus”, “Loaded in PC”, “Image unanalyzed”, “With original image” attributes are stored for the image 4. “Work” and “Interesting person” labels, “White” color information, “Group photo” face information, and “Protection OFF”, “Photographed by own apparatus”, “Unloaded in PC”, “Image analyzed”, “Without original image” attributes are stored for the image 5.

“Soccer” and “Holiday” labels, “Black” color information, “Group photo” face information, and “Protection OFF”, “Photographed by own apparatus”, “Loaded in PC”, “Image analyzed”, “Without original image” attributes are stored for the image N.

As described above, the pieces of metadata that concern the images 1 to N recorded in the recording device 36 and that belong to the label, the color information, the face information, or the attribute categories are stored in the metadata table in FIG. 12 in association with the images 1 to N.

For example, the image retriever 112 retrieves one or more images satisfying the search conditions selected by the user, that is, one or more images having the pieces of metadata of “Work”, “Blue”, “Portrait”, “Unloaded in PC”, “Protection ON”, “Items”, and “Interesting person”, from the images 1 to N recorded in the recording device 36 on the basis of the metadata table shown in FIG. 12.

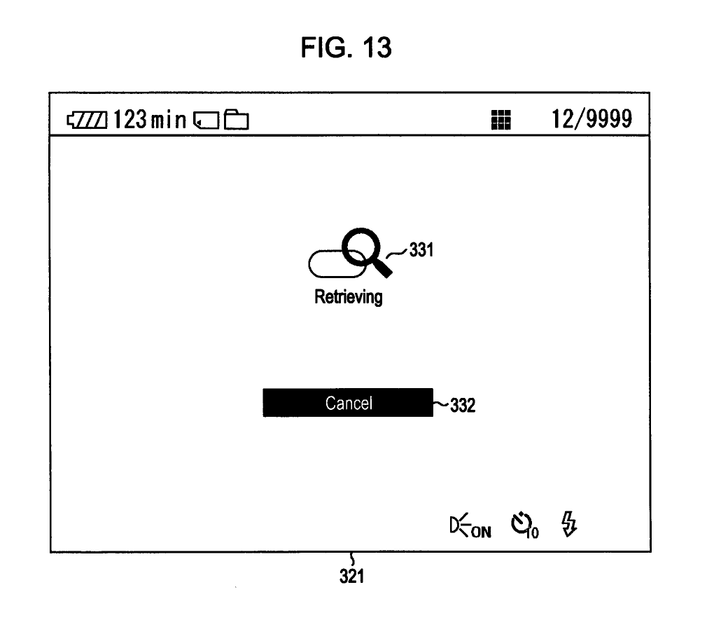

During the image retrieval by the image retriever 112, the display controller 113 displays, for example, a Searching window 321 shown in FIG. 13 on the liquid crystal monitor 11.

Referring to FIG. 13, a “Retrieving” icon 331 indicating that the image is being retrieved is displayed in the central part of the Searching window 321 and a “Cancel” button 332 used for instructing the image retrieval processing unit 101 to cancel the image retrieval is displayed at the bottom side of the “Retrieving” icon 331.

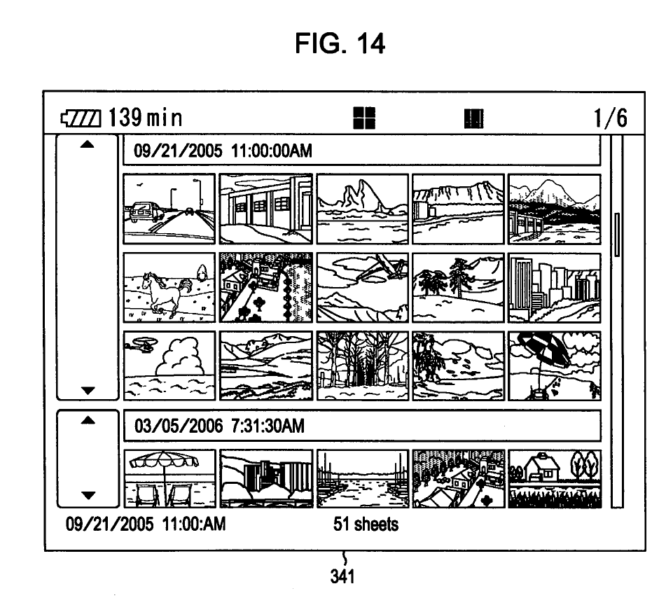

Referring back to the flowchart in FIG. 5, in Step S30, the display controller 113 displays, for example, an image retrieval result window 341 shown in FIG. 14 including the images retrieved by the image retriever 112 on the liquid crystal monitor 11. Then, the image retrieval process by the image retrieval processing unit 101 terminates.

A list of images retrieved by the image retriever 112 is displayed in the image retrieval result window 341 in FIG. 14 (in the example in FIG. 14, 20 images are displayed among 51 images that have been retrieved).

For example, if the user selects the search conditions “Work”, “Blue”, “Portrait”, “Unloaded in PC”, “Protection ON”, “Items”, and “Interesting person”, and selects the “AND search” with the radio button 311 in the retrieval execution window 301 in FIG. 11, the image retriever 112 retrieves the image 2 as the image satisfying all the search conditions on the basis of the metadata table shown in FIG. 12. The display controller 113 displays the image 2 in the image retrieval result window 341 in FIG. 14 as the retrieval result by the image retriever 112.

For example, if the user selects the “OR search”, instead of the “AND search”, with the radio button 311 in the retrieval execution window 301 in FIG. 11 in the above example, the image retriever 112 retrieves the images 1, 2, 3, and 5 as the images satisfying at least one of the search conditions on the basis of the metadata table shown in FIG. 12. The display controller 113 displays the images 1, 2, 3, and 5 in the image retrieval result window 341 in FIG. 14 as the retrieval result by the image retriever 112.

As described above, the image retrieval processing unit 101 can retrieve one or more images by using the pieces of metadata selected across the multiple categories including the label, the color information, the face information, and the attribute as the search conditions (search parameters). As a result, it is possible for the user to easily search a large number of captured images for one or more desired images.

Since the two search methods, the “AND search” and the “OR search”, are provided along with the various search conditions across the multiple categories, the user can easily search for only one or more desired images, such as an image which the user wants to view or print, to display the desired images. Accordingly, it is not necessary for the user to view the images one by one or to group the images into folders when the user wants to search for the images which the user wants to show to other persons.

For example, it is assumed that a user who likes dogs creates a “dog” label and attaches the “dog” label to images of dogs. When the user wants to view the images of the dogs, use of the “dog” label as the search condition allows the user to search for only the images of the dogs. Attaching a “name of own dog” label to his/her own dog and performing the AND search using the “dog” and “name of own dog” labels allow the image of only his/her own dog to be displayed. In the case of a user who likes cats in addition to dogs, attaching a “cat” label to images of cats and performing the OR search using the “dog” and “cat” labels allow the images of dogs and cats to be displayed.

Unlike the cases where images are managed in units of folders, it is possible for the user to search for one or more desired images on the basis of detailed search conditions, such as “dog”, “own dog”, and “dog of Mr. A”. In addition, selection of appropriate search conditions allows the user to search for and display only the desired images without displaying images which the user does not want to show.

Since the color information, the face information, and the attribute can also be selected as the search conditions in addition to the label, it is possible for the user to rapidly search for one or more desired images without fail.

The menu 211 in FIG. 6, the label selection window 221 in FIG. 7, the color information selection window 241 in FIG. 8, the face information selection window 261 in FIG. 9, the attribute selection window 281 in FIG. 10, the retrieval execution window 301 in FIG. 11, the Searching window 321 in FIG. 13, and the image retrieval result window 341 in FIG. 14 are only examples and may have other layouts or aspect ratios.

As described above, the user can appropriately register a desired label in a captured image. A process of attaching a desired label to a certain image will now be described with reference to FIGS. 15 to 23.

FIG. 15 is a flowchart showing an example of the label attachment process by the image retrieval processing unit 101.

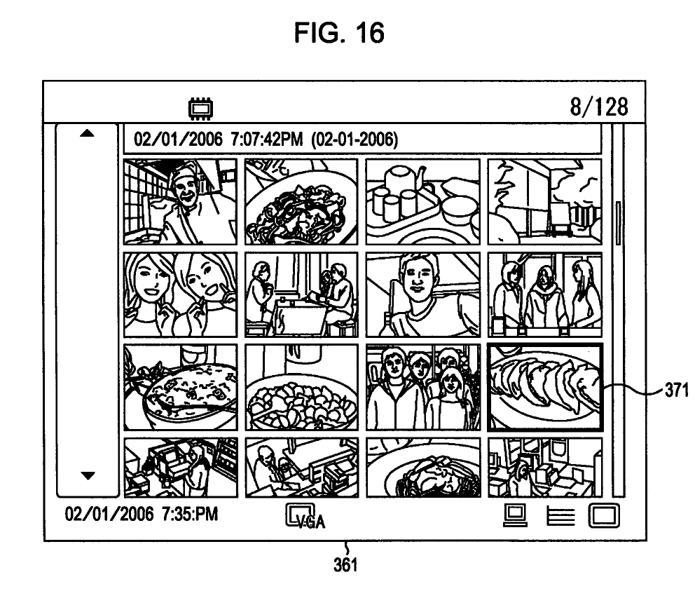

In the digital still camera 1 according to the embodiment of the present invention, for example, an image list window 361 shown in FIG. 16 is displayed on the liquid crystal monitor 11 before the user registers labels in images. In the image list window 361 in FIG. 16, an image of “Meal” which is in the fourth column from the left of the displayed window and in the third line thereof and to which only the “Holiday” label has already been attached is selected with a cursor 371.

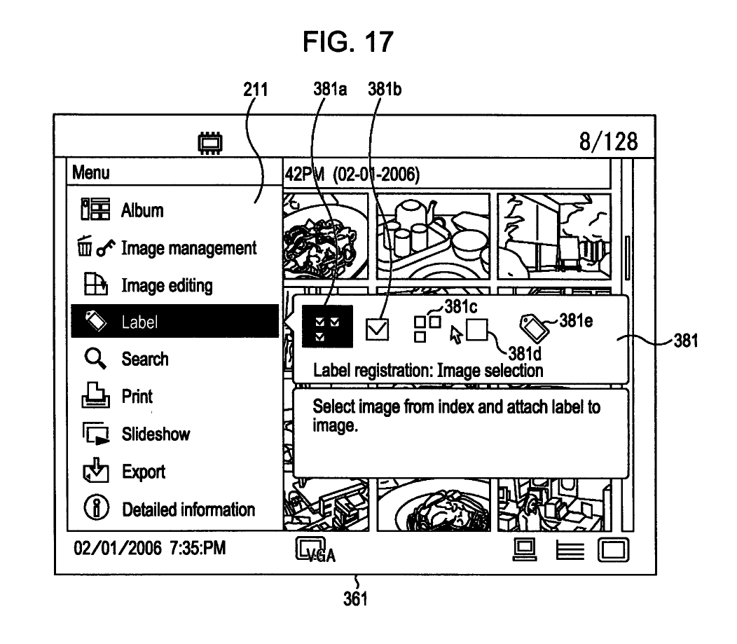

Referring to FIG. 15, in Step S51, the image retrieval processing unit 101 determines whether the user registers a label in an image and selects a label registration menu, for example, from a label 381 displayed by selecting the “Label” from the menu 211 superimposed on the image list window 361 shown in FIG. 17 (that is, the label 381 displayed by selecting the “Label” from the menu 211 superimposed on the image list window 361 in FIG. 16) on the basis of an operation signal supplied from the operation unit 38.

If the image retrieval processing unit 101 determines in Step S51 that the user does not select the label registration menu, the process goes back to Step S51 to repeat the determination until the user selects the label registration menu.

If the image retrieval processing unit 101 determines in Step S51 that the user selects the label registration menu, then in Step S52, the image retrieval processing unit 101 determines whether labels are attached to multiple images on the basis of an operation signal supplied from the operation unit 38.

For example, the image retrieval processing unit 101 determines whether the user selects an icon 381a used for instructing the image retrieval processing unit 101 to attach labels to multiple images from five icons displayed in the label 381 displayed by selecting the “Label” from the menu 211 in the image list window 361 in FIG. 17 to determine whether labels are attached to multiple images.

Of the five icons in the label 381 in FIG. 17, the icon 381a is used for instructing the image retrieval processing unit 101 to attach labels to multiple images. An icon 381b is used for instructing the image retrieval processing unit 101 to attach a label to one image.

An icon 381c is used for instructing the image retrieval processing unit 101 to remove the labels from multiple images. An icon 381d is used for instructing the image retrieval processing unit 101 to remove the label from one image. An icon 381e is used for instructing the image retrieval processing unit 101 to create a new label.

Referring back to FIG. 15, if the image retrieval processing unit 101 determines in Step S52 that the user selects the icon 381b in the label 381 in FIG. 17 to determine that labels are not attached to multiple images, that is, that a label is attached to one image, then in Step S53, the display controller 113 displays only labels that are not attached to the target image under the control of the label processor 114.

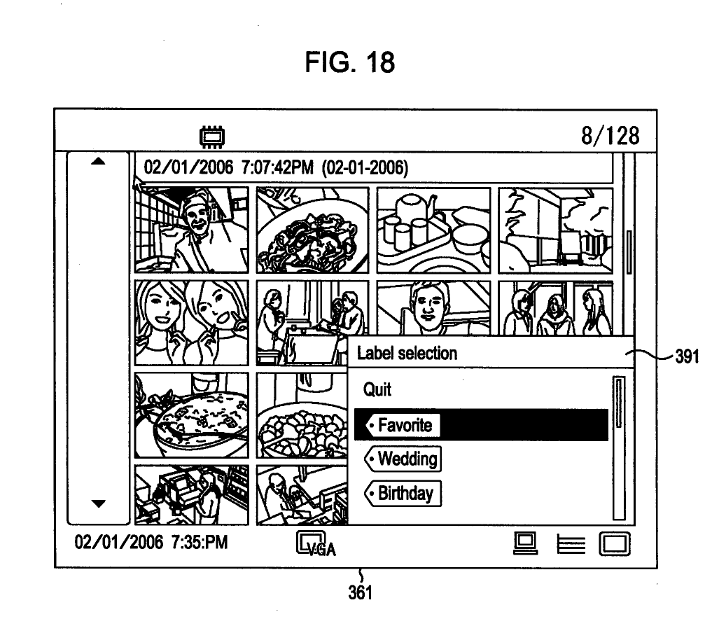

For example, the display controller 113 displays the labels including “Favorite”, “wedding”, and “Birthday” labels, other than the “Holiday” label, for example, in a label selection window 391 shown in FIG. 18 as the labels that are not attached to the “Meal” image selected with the cursor 371 from the list of images in the image list window 361 in FIG. 16.

In Step S54, the image retrieval processing unit 101 determines whether the user selects a desired label from the labels displayed in the label selection window 391 in FIG. 18 on the basis of an operation signal supplied from the operation unit 38.

If the image retrieval processing unit 101 determines in Step S54 that the user does not select a desired label, the process goes back to Step S54 to repeat the determination until the user selects a desired label.

If the image retrieval processing unit 101 determines in Step S54 that the user selects a desired label, then in Step S55, the label processor 114 attaches the selected label to the target image. Then, the label attachment process by the image retrieval processing unit 101 terminates.

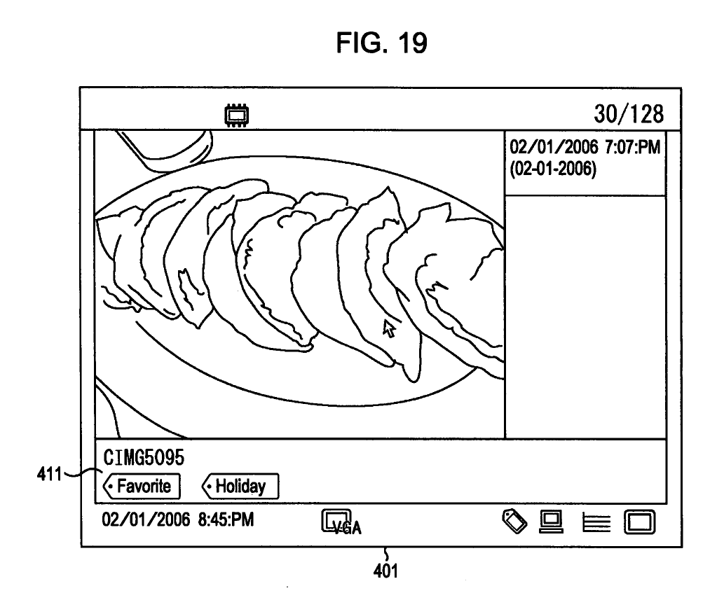

For example, the label processor 114 attaches the “Favorite” label selected from the label selection window 391 in FIG. 18 to the “Meal” image selected with the cursor 371 in FIG. 16. As a result, the “Favorite” label is newly registered in a “Meal” image window 401 shown in FIG. 19, along with the “Holiday” label that has already been registered, as shown in a label display area 411.

If the image retrieval processing unit 101 determines in Step S52 that the user selects the icon 381a in the label 381 in FIG. 17 to determine that labels are attached to multiple images, then in Step S56, the display controller 113 displays all the labels that are registered under the control of the label processor 114.

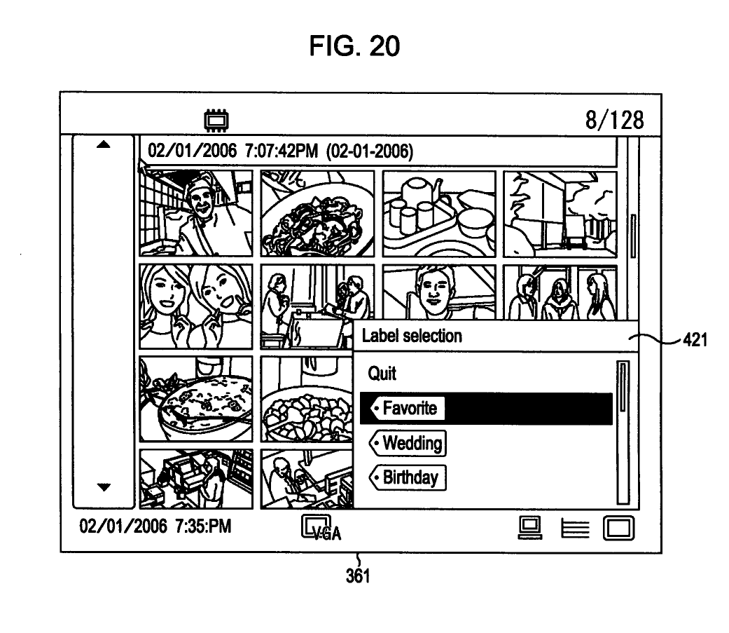

For example, the display controller 113 displays the labels including the “Favorite”, “Wedding”, and “Birthday” labels (including the “Holiday” label attached to the “Meal” image, unlike the case where a label is attached to one image) in, for example, a label selection window 421 shown in FIG. 20.

In Step S57, the image retrieval processing unit 101 determines whether the user selects a desired label from the labels displayed in the label selection window 421 in FIG. 20, as in Step S54.

If the image retrieval processing unit 101 determines in Step S57 that the user does not select a desired label, the process goes back to Step S57 to repeat the determination until the user selects a desired label.

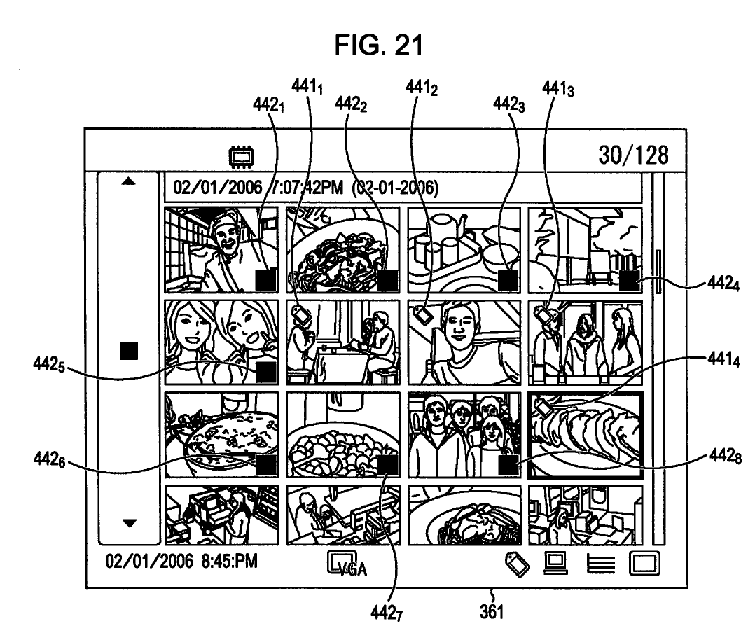

If the image retrieval processing unit 101 determines in Step S57 that the user selects a desired label, then in Step S58, the display controller 113 superimposes, for example, icons 441₁ to 441₄ shown in FIG. 21 on the images to which the selected “Favorite” label has already been attached under the control of the label processor 114.

In the image list window 361 in FIG. 21, the “Favorite” label has already been attached to four images: an image which is in the second column from the left of the displayed window and in the second line thereof, an image which is in the third column from the left of the displayed window and in the second line thereof, an image which is in the fourth column from the left of the displayed window and in the second line thereof, and an image which is in the fourth column from the left of the displayed window and in the third line thereof.

In Step S59, the image retrieval processing unit 101 determines whether the user selects an image to which a label is to be attached, for example, from the image list window 361 in FIG. 21 on the basis of an operation signal supplied from the operation unit 38.

If the image retrieval processing unit 101 determines in Step S59 that the user does not select an image to which a label is to be attached, the process goes back to Step S59 to repeat the determination until the user selects an image to which a label is to be attached.

If the image retrieval processing unit 101 determines in Step S59 that the user selects an image to which a label is to be attached, then in Step S60, the image retrieval processing unit 101 determines whether the user presses an execution button used for instructing the image retrieval processing unit 101 to execute the label attachment on the basis of an operation signal supplied from the operation unit 38.

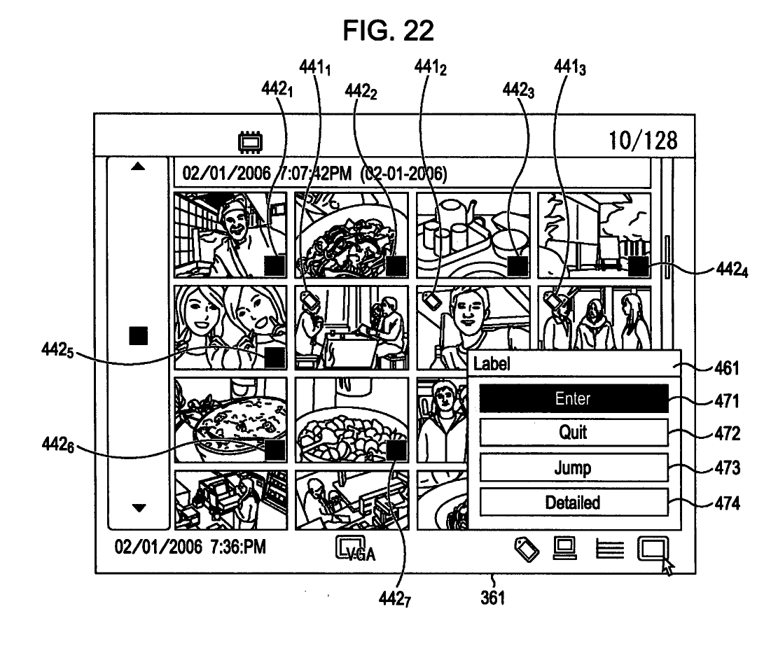

For example, if the user selects the images on which icons 442₁ to 442₈ are superimposed as the images to which the “Favorite” label is to be attached in the image list window 361 in FIG. 21, the image retrieval processing unit 101 determines in Step S60 whether the user presses, for example, an “Enter” button 471 used for instructing the image retrieval processing unit 101 to execute the label attachment in a label attachment execution window 461 superimposed on the image list window 361 in FIG. 22 to determine whether the execution button is pressed.

A “Quit” button 472 used for instructing the image retrieval processing unit 101 to terminate the label attachment, a “Jump” button 473 used for instructing the image retrieval processing unit 101 to jump to another album, and a “Detailed” button 474 instructing the image retrieval processing unit 101 to display detailed information concerning the selected image are displayed in the label attachment execution window 461 in FIG. 22, in addition to the “Enter” button 471.

Referring back to the flowchart in FIG. 15, if the image retrieval processing unit 101 determines in Step S60 that the user does not press the execution button, the process goes back to Step S60 to repeat the determination until the user presses the execution button.

If the image retrieval processing unit 101 determines in Step S60 that the user presses the execution button, then in Step S61, the label processor 114 attaches the label to the selected image. Then, the label attachment process by the image retrieval processing unit 101 terminates.

For example, in the image list window 361 in FIG. 21, the label processor 114 attaches the “Favorite” label to eight images on which the icons 442₁ to 442₈ are superimposed. The eight images include an image which is in the first column from the left of the displayed window and in the first line thereof, an image which is in the second column from the left of the displayed window and in the first line thereof, an image which is in the third column from the left of the displayed window and in the first line thereof, an image which is in the fourth column from the left of the displayed window and in the first line thereof, an image which is in the first column from the left of the displayed window and in the second line thereof, an image which is in the first column from the left of the displayed window and in the third line thereof, an image which is in the second column from the left of the displayed window and in the third line thereof, and an image which is in the third column from the left of the displayed window and in the third line thereof.

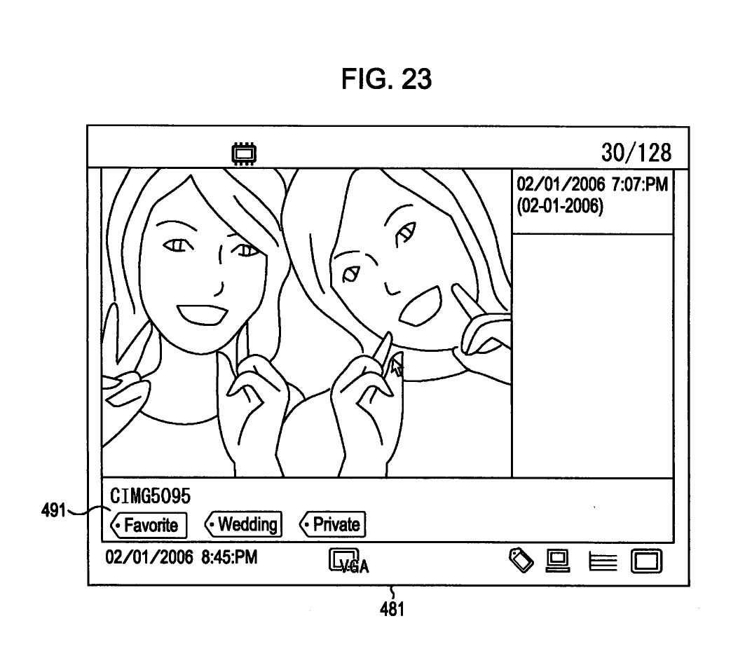

As a result, in addition to the “Wedding” and “Private” labels that have already been registered, the “Favorite” label is newly registered in a “Girl” image window 481 shown in FIG. 23, which is the image in the first column from the left of the displayed window and in the second line thereof in FIG. 21, as shown in a label display area 491.

As described above, the image retrieval processing unit 101 can attach a label or labels to one or more images. Accordingly, the user can rapidly and easily attach a desired label or labels to one or more certain images.

The image list window 361 in FIG. 16, the label 381 displayed by selecting the “Label” from the menu 211 in FIG. 17, the label selection window 391 in FIG. 18, the image window 401 in FIG. 19, the label selection window 421 in FIG. 20, the image list window 361 in FIG. 21, the label attachment execution window 461 in FIG. 22, and the image window 481 in FIG. 23 are only examples and may have other layouts or aspect ratios.

As described above, the user can appropriately remove a label registered in a captured image. A process of removing a label registered in a certain image will now be described with reference to FIGS. 24 to 31.

FIG. 24 is a flowchart showing an example of the label removal process by the image retrieval processing unit 101.

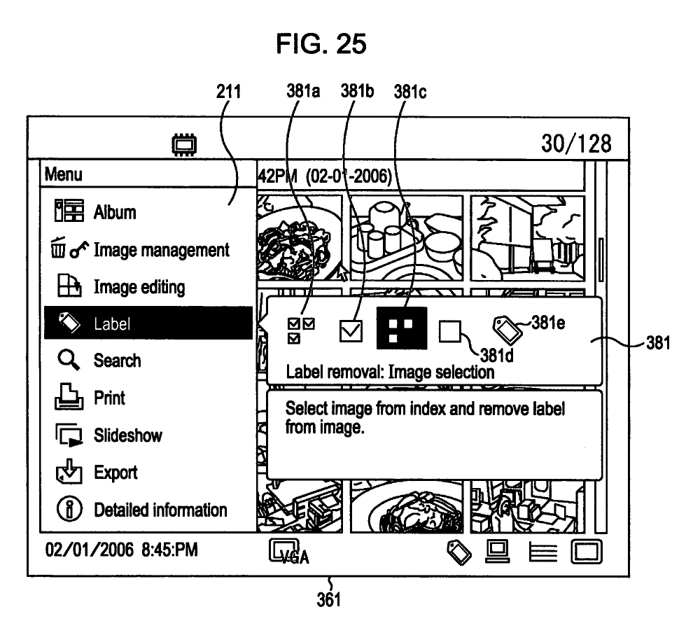

In Step S71 the image retrieval processing unit 101 determines whether the user removes a label registered in an image on the basis of an operation signal supplied from the operation unit 38. For example, the image retrieval processing unit 101 determines whether the user selects a label removal menu from the label 381 displayed by selecting “Label” from the menu 211 superimposed on the image list window 361 shown in FIG. 25.

If the image retrieval processing unit 101 determines in Step S71 that the user does not select the label removal menu, the process goes back to Step S71 to repeat the determination until the user selects the label removal menu.

If the image retrieval processing unit 101 determines in Step S71 that the user selects the label removal menu, then in Step S72, the image retrieval processing unit 101 determines whether labels registered in to multiple images are removed on the basis of an operation signal supplied from the operation unit 38.

For example, the image retrieval processing unit 101 determines whether the user selects the icon 381c used for instructing the image retrieval processing unit 101 to remove the labels registered in multiple images from five icons displayed in the label 381 displayed by selecting the “Label” from the menu 211 in the image list window 361 in FIG. 25 to determine whether labels registered in multiple images are removed.

If the image retrieval processing unit 101 determines in Step S72 that the user selects the icon 381d in the label 381 in FIG. 25 to determine that the labels registered in multiple images are not removed, that is, that the label registered one image is removed, then in Step S73, the display controller 113 displays only the labels that are attached to the target image under the control of the label processor 114.

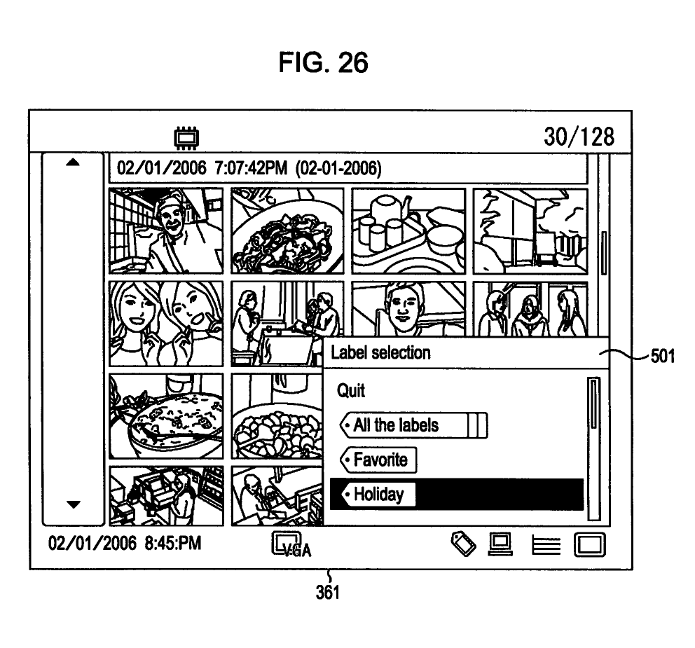

For example, the display controller 113 displays the “Favorite” and “Holiday” labels, for example, in a label selection window 501 shown in FIG. 26 as the labels that are attached to the “Meal” image (the “meal” image window 401 in FIG. 19) selected with the cursor (not shown) from the list of images in the image list window 361 in FIG. 25.

In Step S74, the image retrieval processing unit 101 determines whether the user selects a desired label from the labels displayed in the label selection window 501 in FIG. 26 on the basis of an operation signal supplied from the operation unit 38.

If the image retrieval processing unit 101 determines in Step S74 that the user does not select a desired label, the process goes back to Step S74 to repeat the determination until the user selects a desired label.

If the image retrieval processing unit 101 determines in Step S74 that the user selects a desired label, then in Step S75, the label processor 114 removes the selected label from the target image. Then, the label removal process by the image retrieval processing unit 101 terminates.

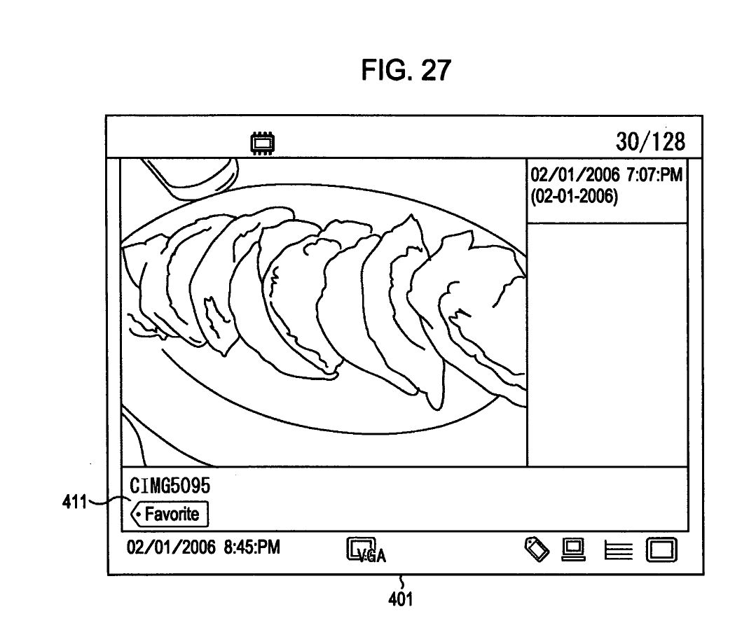

For example, the label processor 114 removes the “Holiday” label selected by the user from the label selection window 501 in FIG. 26, from among the “Favorite” and “Holiday” labels registered in the “meal” image window 401 in FIG. 19. As a result, the “Holiday” label is removed from the “Meal” image window 401 shown in FIG. 27 and only the “Favorite” label is left, as shown in the label display area 411.

If the image retrieval processing unit 101 determines in Step S72 that the user selects the icon 381c in the label 381 in FIG. 25 to determine that the labels registered in multiple images are removed, then in Step S76, the display controller 113 displays all the labels that are registered under the control of the label processor 114.

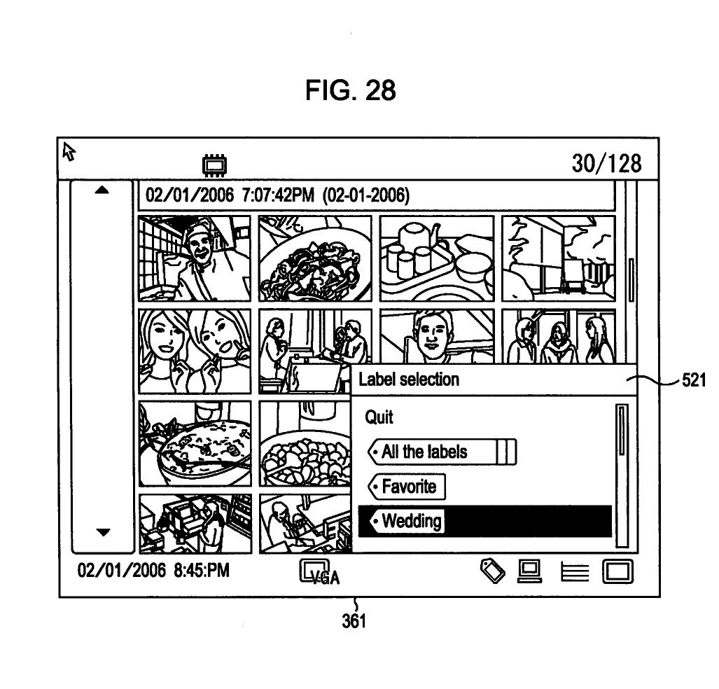

For example, the display controller 113 displays the labels including the “Favorite” and “Wedding” labels (all the registered labels including the “Favorite” and “Holiday” labels attached to the “meal” image, unlike the case where the label is removed from one image) in, for example, a label selection window 521 shown in FIG. 28.

In Step S77, the image retrieval processing unit 101 determines whether the user selects a desired label from the labels displayed in the label selection window 521 in FIG. 28, as in Step S74.

If the image retrieval processing unit 101 determines in Step S77 that the user does not select a desired label, the process goes back to Step S77 to repeat the determination until the user selects a desired label.

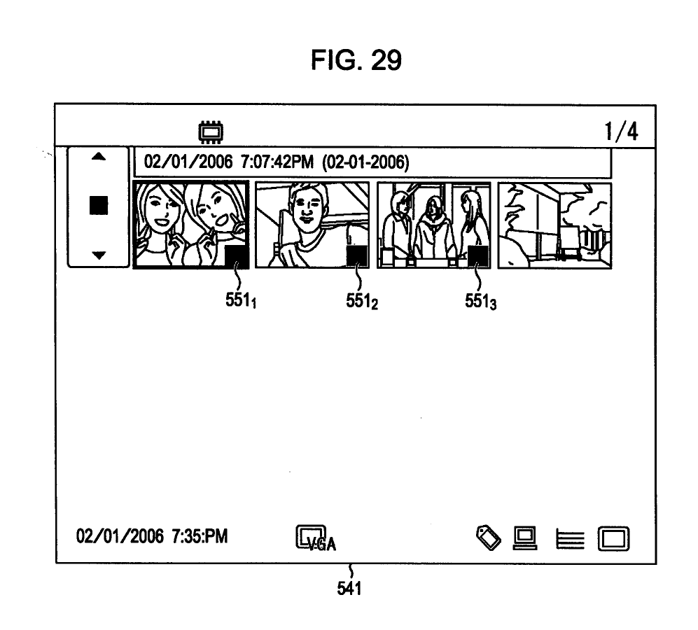

If the image retrieval processing unit 101 determines in Step S77 that the user selects a desired label, then in Step S78, the display controller 113 displays, for example, the images to which the selected “Wedding” label is attached in, for example, a removal image list window 541 shown in FIG. 29 under the control of the label processor 114. Specifically, the display controller 113 displays four images in the removal image list window 541 in FIG. 29 as the images to which the “Wedding” label has already been registered.

In Step S79, the image retrieval processing unit 101 determines whether the user selects an image from which a label is to be removed, for example, from the removal image list window 541 in FIG. 29 on the basis of an operation signal supplied from the operation unit 38.

If the image retrieval processing unit 101 determines in Step S79 that the user does not select an image from which a label is to be removed, the process goes back to Step S79 to repeat the determination until the user selects an image from which a label is to be removed.

If the image retrieval processing unit 101 determines in Step S79 that the user selects an image from which a label is to be removed, then in Step S80, the image retrieval processing unit 101 determines whether the user presses an execution button used for instructing the image retrieval processing unit 101 to execute the label removal on the basis of an operation signal supplied from the operation unit 38.

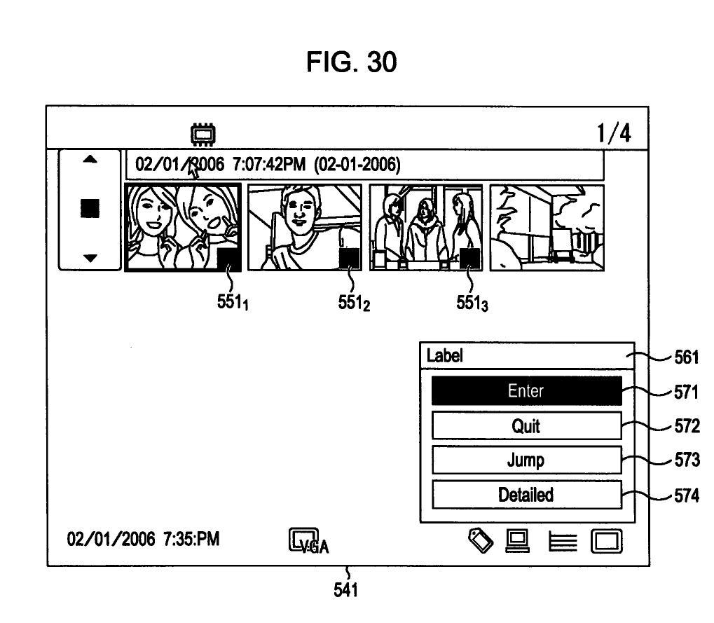

For example, if the user selects the images on which icons 551₁ to 551₃ are superimposed as the images from which the “Wedding” label is to be removed in the removal image list window 541 in FIG. 29, the image retrieval processing unit 101 determines in Step S80 whether the user presses, for example, an “Enter” button 571 used for instructing the image retrieval processing unit 101 to execute the label removal in a label removal execution window 561 superimposed on the removal image list window 541 in FIG. 30 to determine whether the execution button is pressed.

A “Quit” button 572 used for instructing the image retrieval processing unit 101 to terminate the label removal, a “Jump” button 573 used for instructing the image retrieval processing unit 101 to jump to another album, and a “Detailed” button 574 instructing the image retrieval processing unit 101 to display detailed information concerning the selected image are displayed in the removal image list window 541 in FIG. 30, in addition to the “Enter” button 571.

Referring back to the flowchart in FIG. 24, if the image retrieval processing unit 101 determines in Step S80 that the user does not press the execution button, the process goes back to Step S80 to repeat the determination until the user presses the execution button.

If the image retrieval processing unit 101 determines in Step S80 that the user presses the execution button, then in Step S81, the label processor 114 removes the label from the selected image. Then, the label removal process by the image retrieval processing unit 101 terminates.

For example, in the removal image list window 541 in FIG. 29, the label processor 114 removes the “wedding” label registered in the first to third images from the left on which the user superimposes the icons 551₁ to 551₃.

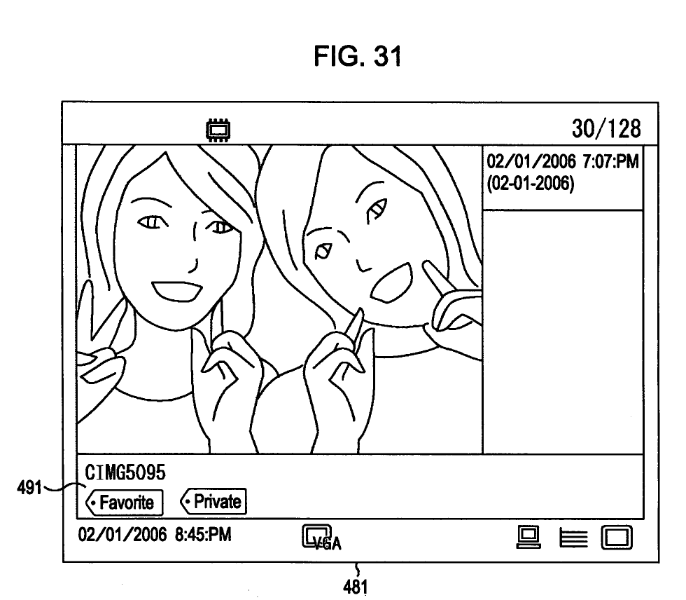

As a result, the “wedding” label is removed from the “Favorite”, “Wedding”, and “Private” labels registered in the “Girl” image window 481 in FIG. 23 and only the “Favorite” and “Private” labels are left in the “Girl” image window 481 shown in FIG. 31, which is the first image from the left in FIG. 29, as shown in the label display area 491.

As described above, the image retrieval processing unit 101 can remove a label registered in one or more images. Accordingly, the user can rapidly and easily remove a desired label from the labels registered in one or more certain images.

The label 381 displayed by selecting the “Label” from the menu 211 in FIG. 25, the label selection window 501 in FIG. 26, the image window 401 in FIG. 27, the label selection window 521 in FIG. 28, the removal image list window 541 in FIG. 29, the label removal execution window 561 in FIG. 30, and the image window 481 in FIG. 31 are only examples and may have other layouts or aspect ratios.

As described above, the user can create a new label to be registered in an image. A process of creating a new label will now be described with reference to FIGS. 32 to 36.

FIG. 32 is a flowchart showing an example of the label creation process by the image retrieval processing unit 101.

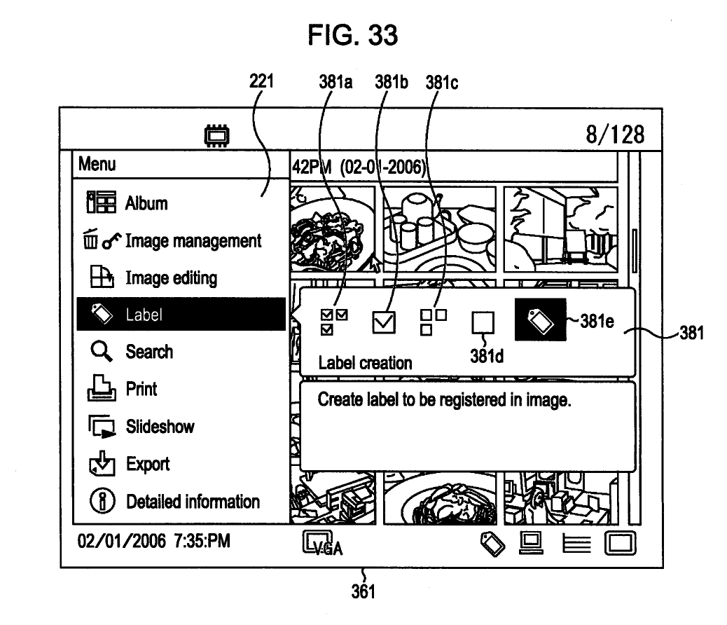

In Step S91, the image retrieval processing unit 101 determines whether the user creates a new label on the basis of an operation signal supplied from the operation unit 38. For example, the image retrieval processing unit 101 determines whether the user selects the icon 381e used for instructing the image retrieval processing unit 101 to create a new label from the label 381 displayed by selecting “Label” from the menu 211 superimposed on the image list window 361 shown in FIG. 33 to determine whether the user selects a label creation menu.

If the image retrieval processing unit 101 determines in Step S91 that the user does not select the label creation menu, the process goes back to Step S91 to repeat the determination until the user selects the label creation menu.

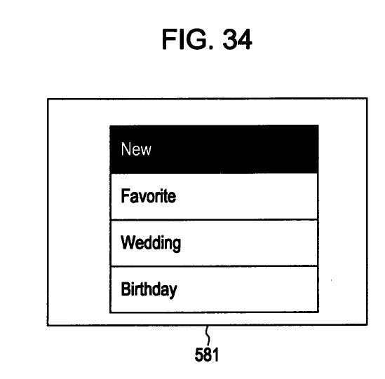

If the image retrieval processing unit 101 determines in Step S91 that the user selects the label creation menu, then in Step S92, the display controller 113 displays, for example, a label list window 581 shown in FIG. 34 under the control of the label processor 114.

Referring to FIG. 34, a “New” label used for instructing the image retrieval processing unit 101 to create a new label is displayed in the label list window 581, in addition to the “Favorite”, “wedding”, and “Birthday” labels that have already been registered.

Referring back to the flowchart in FIG. 32, in Step S93, the image retrieval processing unit 101 determines whether the user selects, for example, the “New” label in the label list window 581 in FIG. 34 on the basis of an operation signal supplied from the operation unit 38.

If the image retrieval processing unit 101 determines in Step S93 that the user does not select the “New” label, the process goes back to Step S93 to repeat the determination until the user selects the “New” label.

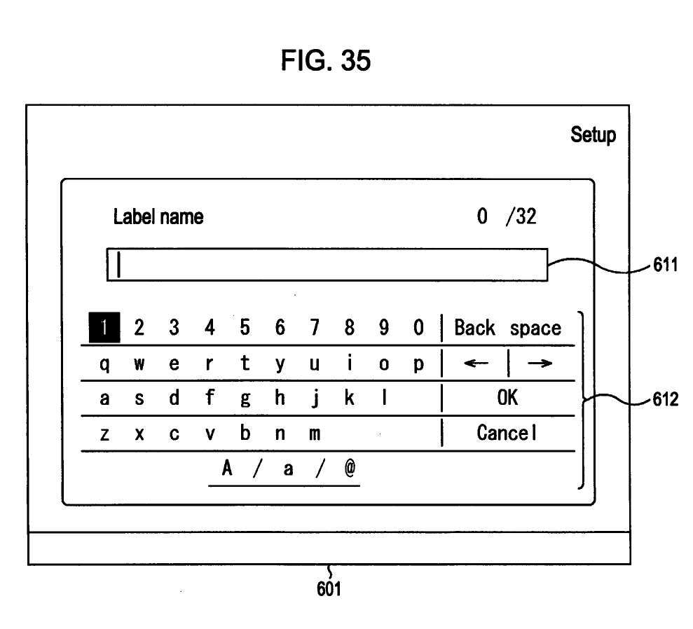

If the image retrieval processing unit 101 determines in Step S93 that the user selects the “New” label, then in Step S94, the display controller 113 displays, for example, an input window 601 shown in FIG. 35 on the liquid crystal monitor 11.

The input window 601 in FIG. 35 is an example of a window with which the text of a label is input. A text box 611 in which an input character string is displayed and an input board 612 that include various buttons of alphanumeric characters and symbols and that are used for inputting characters in the text box 611 are displayed in the input window 601.

Referring back to the flowchart in FIG. 32, in Step S95, the image retrieval processing unit 101 receives the character string input by the user on the basis of an operation signal supplied from the operation unit 38. For example, if the user operates the input window 601 in FIG. 35 to input the character string “Friends”, the image retrieval processing unit 101 receives the input character string. The display controller 113 displays the input character string “Friends” in the text box 611 in the input window 601 in FIG. 35.

In Step S96, the image retrieval processing unit 101 determines whether the user presses a certain button to perform a label creation operation on the basis of an operation signal supplied from the operation unit 38.

If the image retrieval processing unit 101 determines in Step S96 that the user does not perform the label creation operation, the process goes back to Step S95 to repeat Steps S95 and S96 until the user performs the label creation operation.

If the image retrieval processing unit 101 determines in Step S96 that the user performs the label creation operation, then in Step S97, the label processor 114 creates a label from, for example, the character string “Friends” input by the user.

In Step S98, the label processor 114 stores the created label, such as the “Friends”, along with the other labels stored in the storage unit 42. Then, the label creation process by the image retrieval processing unit 101 terminates.

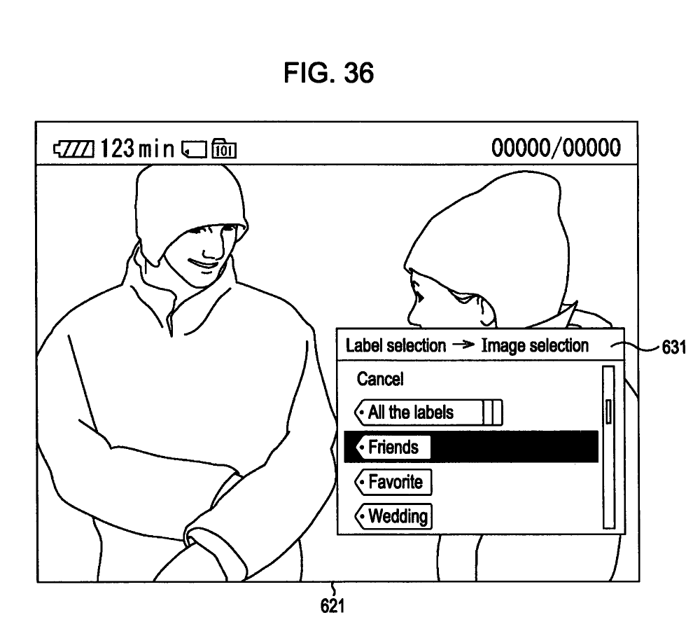

When the user registers a label in, for example, a “Friends” image window 621 shown in FIG. 36, the “Friends” label newly created is displayed in a label selection window 631, which is a list of labels that can be registered, along with the created labels, such as the “Favorite” and “Wedding” labels. As a result, the “Friends” label can be registered in the “Friends” image window 621 in FIG. 36.

If the digital still camera 1 does not have the character input function, such as the input window 601, the digital still camera 1 may be connected to an apparatus, such as a personal computer, having the character input function via a universal serial bus (USB). An application program used for registering labels in the digital still camera 1 may be invoked in the personal computer, and the creation of a label and the registration of the created label in the digital still camera 1 may be realized through the application program. Specifically, characters are input with a keyboard connected to the personal computer to create a desired label, and the created label is transferred to the digital still camera 1 via the USB. The digital still camera 1 registers the received label.

The image retrieval processing unit 101 can create a new label in the manner described above.

An apparatus that does not have the character input function cannot attach a label using characters and can only attach a label that is prepared in advance in the apparatus, whereas the digital still camera 1 can create a new desired label.

Accordingly, for example, a user who likes playing soccer can create a “Soccer” label or a user who have a child (children) can create “Child”, “Sports festival”, and “Birthday” labels to register the desired labels in images.

The label 381 displayed by selecting the “Label” in the label selection window 221 in FIG. 33, the label list window 581 in FIG. 34, the input window 601 in FIG. 35, and the image window 621 in FIG. 36 are only examples and may have other layouts or aspect ratios.

As described above, since images are retrieved by using the metadata selected across multiple categories, it is possible for the user to easily search for a desired image.

The image analysis processing in the digital still camera 1 may be performed by another apparatus, such as a personal computer, and only the result of the processing may be loaded in the digital still camera 1.

The steps describing the programs stored in the recording medium may be performed in time series in the described order or may be performed in parallel or individually.

It should be understood by those skilled in the art that various modifications, combinations, sub-combinations and alterations may occur depending on design requirements and other factors insofar as they are within the scope of the appended claims or the equivalents thereof.

1. An image retrieval apparatus retrieving an image, the apparatus comprising:
metadata selecting means for selecting metadata that concerns the image and that belongs to any of a plurality of categories in response to an operation by a user;
image retrieving means for retrieving the image on the basis of the metadata selected across the plurality of categories; and
display controlling means for controlling display of the retrieved image.

2. The image retrieval apparatus according to claim 1, wherein the plurality of categories include a label that is information concerning a text registered by the user, color information that concerns the proportion of a color in the image, face information that concerns a face displayed in the image, and an attribute of the image, and wherein the metadata belongs to any of the label, the color information, the face information, and the attribute.

3. The image retrieval apparatus according to claim 2, wherein the attribute indicates information concerning an apparatus that captures the image, whether the image is protected, whether the image is loaded in another apparatus, whether certain image analysis processing is performed to the image, or whether the original of the image exists.

4. The image retrieval apparatus according to claim 2, further comprising a label processing means for attaching the label to one or more images in response to an operation by the user.

5. The image retrieval apparatus according to claim 4, wherein the label processing means removes the label attached to one or more images in response to an operation by the user.

6. The image retrieval apparatus according to claim 4, wherein the label processing means creates the label in response to an operation by the user.

7. The image retrieval apparatus according to claim 1, wherein the image retrieving means retrieves the image by using logical addition or logical multiplication of the metadata selected across the plurality of categories as a search condition.

8. An image retrieval method for an image retrieval apparatus retrieving an image, the method comprising:
selecting metadata that concerns the image and that belongs to any of a plurality of categories in response to an operation by a user;
retrieving the image on the basis of the metadata selected across the plurality of categories; and
controlling display of the retrieved image.

9. A program causing a computer to perform image retrieval processing, the program comprising:
selecting metadata that concerns the image and that belongs to any of a plurality of categories in response to an operation by a user;
retrieving the image on the basis of the metadata selected across the plurality of categories; and
controlling display of the retrieved image.

10. An image pickup apparatus capturing an image, the apparatus comprising:
recording means for recording the captured image;
metadata selecting means for selecting metadata that concerns the recorded image and that belongs to any of a plurality of categories in response to an operation by a user;
image retrieving means for retrieving the recorded image on the basis of the metadata selected across the plurality of categories; and
display controlling means for controlling display of the retrieved image in display means.

11. An image retrieval apparatus retrieving an image, the apparatus comprising:
a metadata selecting unit selecting metadata that concerns the image and that belongs to any of a plurality of categories in response to an operation by a user;
an image retrieving unit that retrieves the image on the basis of the metadata selected across the plurality of categories; and
a display controlling unit that controls display of the retrieved image.

12. An image pickup apparatus capturing an image, the apparatus comprising:
a recording unit that records the captured image;
a metadata selecting unit selecting metadata that concerns the recorded image and that belongs to any of a plurality of categories in response to an operation by a user;
an image retrieving unit that retrieves the recorded image on the basis of the metadata selected across the plurality of categories; and
a display controlling unit that controls display of the retrieved image in a display unit.
